(19) United States
(12) Patent Application Publication
(10) Pub. No.: US 2019/0106614 A1
(43) Pub. Date: Apr. 11, 2019

(54) LOW SOLIDS OIL BASED WELL FLUID WITH PARTICLE-STABILIZED EMULSION

(71) Applicant: Cabot Specialty Fluids, Inc., Boston, MA (US)

(72) Inventors: Ravi Sharma, Acton, MA (US); Lukasz Grzybek, Aberdeen (GB); Siv K. Howard, Houston, TX (US)

(21) Appl. No.: 15/763,021

(22) PCT Filed: Sep. 9, 2016
(86) PCT No.: PCT/US2016/050964

§ 371 Date: Mar. 23, 2018

Related U.S. Application Data
(60) Provisional application No. 62/234,054, filed on Sep. 29, 2015.

(51) Int. Cl. C09K 8/36; B01F 17/00

(52) U.S. Cl. CPC C09K 8/36; B01F 17/0007

(57) ABSTRACT

A well fluid has a particle stabilized emulsion that has a first phase containing hydrocarbon fluid, a second phase containing brine, such as an aqueous alkali metal brine, and solid particles, wherein at least a portion of the solid particles are arranged at an interface between the first phase and the second phase to stabilize the emulsion. The well fluids can be used for drilling, completion, and/or workover fluids. A method of preparing the well fluid, which can be done in the absence of a surfactant, is also described.

### RELATED APPLICATIONS

This application claims priority under 35 U.S.C. § 119(e) to U.S. Prov. App. No. 62/234,054, filed Sep. 29, 2015, the disclosure of which is incorporated herein by reference.

### BACKGROUND OF THE INVENTION

The present invention relates to hydrocarbon recovery and to the drilling industry and more particularly relates to well fluids used to recover hydrocarbons, and also relates to uses thereof in hydrocarbon recovery operations as a drilling, completion, workover, or other well fluids, and to methods of making well fluids.

In drilling operations, such as the drilling that occurs in oil field operations, for instance performed on dry land or offshore using oil platforms, drilling fluids are designed/formulated to serve several functions. Liquid drilling fluid is often called drilling mud. The functions include acting as a lubricant to the drill bit to reduce wear and friction during drilling and also to seal the formation surface by forming a filter cake. In the drilling fluid, agents for lubrication typically are present as well as weighting materials in order to achieve a density that typically produces a pressure greater than the surrounding pressure in the well bore. This overpressure is vital for maintaining wellbore stability and well control. In drilling operations, solid weighting materials are commonly added to the drilling fluid to give sufficient density to the fluid to hinder inflow of oil or gas into the wellbore from the downhole formation. The weighting materials can be soluble salts or finely-ground insoluble particles. Water insoluble weighting materials can be barite, calcite, mullite, galena, manganese oxides, iron oxides, and water soluble weighting materials can be water soluble salts of zinc, iron, barium, calcium. Heavy halide salts, such as barium sulphate (barite), calcium bromide, zinc bromide, and cesium salts, such as cesium formate, have been used as weighting materials. Halide salt and cesium formate weighting materials, for example, have been used in heavy clear brines used in well service emulsion fluids prepared with surfactant sufficient to create the emulsion. U.S. Pat. No. 6,562,764 B1, for example, shows well service fluid compositions using emulsions that are prepared with nonionic surfactant emulsifiers.

Furthermore, the drilling fluid can also typically contain a sealing or fluid loss agent, such as calcium carbonate, polysaccharides, and other polymers, in order to form the filter cake on the formation surface of the well bore. In addition, when the drilling fluids are used during drilling, the drilling fluid will also contain drilling fines, such as shale and sandstone fines.

In the drilling industry, typically water based muds (WBMs), oil-based muds (OBMs), or synthetic-based muds (SBMs) are used in well drilling operations. Water-based muds typically have a continuous water phase into which salts, polymers, and various other chemicals typically are incorporated to create a homogenous blend. With the exception of those based on formate and acetate brines, the water-based drilling fluids may not have operational capabilities suitable for more extreme drilling conditions, such as drilling of deep wells, high pressure/high temperature wells, and the like. Oil-based muds typically include a continuous phase which comprises a hydrocarbon oil (or synthetic oil or ester in the instance of SBMs), a discontinuous phase which typically comprises an aqueous solution, and surfactants. Typically, one or more other agents or additives, such as for weight or density, suspension, oil-wetting, lubrication, fluid loss or filtration control, and rheology control, can be also included in the oil-based muds.

Once drilling operations have been completed, the well typically is prepared for the completion operations whereby the mud used for drilling is often displaced by a completion fluid. Completion fluids typically are water-based clear fluids and are formulated to the same density as the drilling fluid used to drill the well, in order to retain the hydraulic pressure on the well bore. There are numerous methods of completing a well, amongst which are open hole completions and gravel packed screened systems.

As indicated, high density cesium formate brine has been used for drilling and completion of oil and gas wells. There are several types of fluids currently being used that are based on cesium formate brine, which are drilling fluids, completion fluids, and low solids oil based muds (or LSOBM) screen running fluids. Due to the high cost and limited supply of cesium salt, there is a need to prevent loss of cesium salt during use in well operations. Where these fluids are used in the form of emulsions, surfactants typically has been used to create the emulsion.

However, LSOBMs and other well service fluids made using surfactants can produce invert emulsions with limited stability. A need exists for LSOBMs and other well service fluids that would have greater stability during their use in well operations and permits the use of denser salts with reduced risk of damage to the formation.

### SUMMARY OF THE PRESENT INVENTION

A feature of the present invention is to provide well fluids (e.g., drilling, completion, and/or workover fluids or others) that use salts, such as cesium salts, in emulsions having increased stability.

A further feature of the present invention is to provide high density well fluids with high temperature stability that use brine or salts in particle stabilized emulsions that can be prepared without need of surfactants.

Another feature of the present invention is to provide a well fluid which contains a particle stabilized emulsion comprising an aqueous brine in an internal phase thereof. This can reduce loss of the metal salts that may be used, in wells and supports the use of higher density brines.

A further feature of the present invention is to provide a well fluid which contains a particle stabilized emulsion comprising a high density aqueous alkali metal-phosphate brine in an internal phase thereof to reduce opportunities for contact of the phosphate brine with an oil-bearing rock formation.

Another feature of the present invention is to provide a well fluid which contains a particle stabilized emulsion that contains an aqueous alkali metal salt brine, which are stable invert emulsions suitable for use as drilling, completion, and workover fluids under a wide range of application conditions, such as in deep wells, high temperature/pressure wells, or other extreme application conditions.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a well fluid comprising a particle stabilized emulsion, wherein the emulsion comprises a first phase comprising hydrocarbon fluid, a second phase comprising brine such as an alkali metal brine, for instance an aqueous cesium brine, and solid particles, such as solid silica particles, wherein at least a portion of the solid particles are arranged at an interface between the first phase and the second phase.

The present invention further relates to a method for producing a particle stabilized emulsion for well fluids, comprising dispersing solid particles (such as solid silica particles) in a hydrocarbon fluid to form a dispersion, adding aqueous brine to the dispersion to form a mixture, and emulsifying the mixture to form an emulsion comprising a first phase comprising hydrocarbon fluid, a second phase comprising an aqueous brine, wherein at least a portion of the solid particles are arranged at an interface between the first phase and the second phase.

The present invention further relates to a method to drill a well comprising drilling said well in the presence of the indicated well fluid.

It is to be understood that both the foregoing general description and the following detailed description are exemplary and explanatory only and are intended to provide a further explanation of the present invention, as claimed.

The accompanying drawings, which are incorporated in and constitute a part of this application, illustrate several features of the present invention and together with the description, serve to explain the principles of the present invention.

### BRIEF DESCRIPTION OF THE DRAWINGS

FIG. 1 is schematic representation of the position of a particle at an oil-water interface and of the characteristic contact angle θ (measured through the water phase) adopted by the particle at the interface.

FIG. 2 (θ<90°) and FIG. 3 (θ>90°) are schematic representations showing the behavior of particles as emulsifiers as a function of their contact angle for two particles with a different wettability for the interface resulting in different contact angles.

FIG. 4 shows a characteristic resulting emulsion type obtained when emulsifying a 1:1 oil:water system using the contact angle shown in FIG. 2.

FIG. 5 shows a characteristic resulting emulsion type obtained when emulsifying a 1:1 oil:water system using the contact angle shown in FIG. 3.

FIG. 6 shows particle size distribution of an emulsion in accordance with an example of the present application.

FIG. 7 shows a graph which shows coalescence data for emulsions stabilized by 1 wt % and 5 wt % colloidal silica (TG-C413) in accordance with an example of the present application.

FIG. 8 shows the results of particle size analysis that was performed on an emulsion that is stabilized by colloidal silica (TG-C390) with 1 wt % surfactant (KemVert™ 1764) in accordance with an example of the present application.

FIG. 9 shows the results of particle size analysis that was performed on an emulsion that is stabilized by colloidal silica (TG-C390) with 1 wt % of surfactant (KemVert™ 1899) in accordance with an example of the present application.

FIG. 10 shows a cryogenic SEM image at 50,000× magnification of an emulsion system that was stabilized by colloidal silica (TG-C390) at 15 wt % and which also contained surfactant (KemVert™ 1899) at 1 wt %, which shows that there are silica particles at the interface, in accordance with an example of the present application.

FIG. 11 shows a cryogenic SEM image at 50,000× magnification of an emulsion system that was stabilized by colloidal silica (TG-C390) at 15 wt % in accordance with an example of the present application.

FIG. 12 shows a cryogenic SEM image at 25,000× magnification of the same emulsion system as shown in FIG. 11, in accordance with an example of the present application.

FIG. 13 shows the results of a particle size analysis of a Cs₂HPO₄ emulsion, in accordance with an example of the present application.

FIG. 14 shows a cryogenic SEM image at 2500× magnification of a Cs₂HPO₄ emulsion that is stabilized with 15 wt % colloidal silica (TG-C390), in accordance with an example of the present application.

FIG. 15 shows a cryogenic SEM image of the same emulsion system as shown in FIG. 11, at 25,000 magnification, in accordance with an example of the present application.

FIG. 16 is a photographic image of an emulsion (sample AL214_3) prepared with 15 wt % colloidal silica (TG-C390) and 1 wt % surfactant (KemVert™ 1899), and 4 wt % organoclay (Bentone® 38), taken after the emulsion is subjected to a Hot Rolling Test in accordance with an example of the present application.

FIG. 17 is a photographic image of a standard low solids oil based muds (LSOBM), taken after the emulsion is subjected to a Hot Rolling Test.

FIG. 18 is a photographic image of an emulsion (sample AL190) prepared with 15 wt % colloidal silica (TG-C390), taken after the emulsion is subjected to a Hot Rolling Test in accordance with an example of the present application.

FIG. 19 is a photographic image of the standard low solids oil based muds (LSOBM), taken after the emulsion is subjected to a centrifugation test.

FIG. 20 is a photographic image of the emulsion (sample AL190) prepared with 15 wt % colloidal silica (TG-C390) after the emulsion is subjected to a centrifugation test in accordance with an example of the present application.

FIG. 21 shows particle size distributions of LSOBM and emulsions (sample AL190) prepared in accordance with an example of the present application before and after hot rolling.

FIG. 22 shows particle size distributions of emulsions (sample AL190) prepared in accordance with an example of the present application before and after hot rolling at various temperatures and durations.

FIG. 23 shows particle size distribution of emulsions (sample AL190_6) containing colloidal silica and fumed silica prepared in accordance with an example of the present application before and after hot rolling at various temperatures and durations.

### DETAILED DESCRIPTION OF THE PRESENT INVENTION

The present invention relates to well fluids for use in hydrocarbon recovery operations. The well fluids can comprise a particle stabilized emulsion that includes an oil phase and an aqueous brine phase, such as an alkali metal salt-containing phase, such as a cesium salt-containing phase. At least a portion of solid stabilizing particles are arranged at an interface between the two liquid phases of oil and aqueous brine phase where the stabilizing particles can form a barrier against the coalescence of liquid droplets. This promotes the formation and/or stability of the emulsion. These particle stabilized emulsions for well fluids can remove the need for surfactants to form and/or maintain the emulsion. The stabilizing particles can be solid silica particles and/or other solid particles having similar effect such as described herein. Solid particles refer to water-insoluble particles that are dispersed intact or essentially intact in the emulsion composition (in the hydrocarbon and/or aqueous phases thereof). The solid particles are not dissolved in either of the hydrocarbon or aqueous phases of the emulsion.

An aqueous brine phase is used in the present invention as one of the phases for a particle stabilized emulsion of the present invention. An aqueous brine is quite different from just an aqueous solution or a water based solution. This is especially true for heavy brines. While the concentration of salt to form the brine, which can also be referred to as the concentration of brine, can vary, one option in the present invention is to utilize heavy brines such as brines having a density of 1.5 g/cm³ or more such as from 1.5 g/cm³ to 3 g/cm³ with regard to density. In the present invention, the brine can be formed from one or more salts, such as one or more alkali metal salts and/or bromide salts, such as alkali metal formates, such as cesium formate. The brine can be a result of blends of any salts such as cesium salts, and/or potassium salts, and/or halide salts. The brine can be an alkali metal brine, and/or a halide brine (bromide brine, a chloride brine, and the like). For instance, the brine can be a potassium brine such as a potassium phosphate brine, a potassium formate brine, a cesium formate brine, a cesium phosphate brine, a cesium acetate brine, a bromide brine, a chloride brine, or other alkali metal brine(s), or any combination of one or more of these salts that form the brine. The alkali metal salts that can be used in the brine phase can be one or more cesium salts, sodium salts, potassium salts, and/or rubidium salts, or others. The aqueous alkali metal salt-containing phase of the particle stabilized emulsion can be an aqueous cesium salt-containing phase, which can be brine or other aqueous fluid in which at least one kind of cesium salt is dissolved, dispersed, or both.

Particle stabilized emulsions (e.g., silica particle stabilized emulsions) of oil and brines for well fluids are found to have much greater stability than surfactant-based emulsions of these materials. Further, the presence of surfactant during the preparation of the particle stabilized emulsion can be undesirable as it can degrade the stability of the particle stabilized emulsion, such as shown in examples included herein. The addition of surfactant prior to completing the formation of the particle-stabilized emulsion can degrade the thermal stability of the resulting product in comparison to surfactant-free preparations of the emulsion. The particle stabilized emulsions of the present invention can be prepared in the absence of such surfactants and without need of surfactants to achieve a stable emulsion product. The particle stabilized emulsions, once prepared, also can be sustained and used after preparation in wells under downhole conditions in the absence of surfactants (or, as an option, in the co-presence of such additives in well fluid as added after preparation of the particle-stabilized emulsion). Further, these particle stabilized emulsions can also reduce cesium or other salt losses and support the use of the higher density brines in well fluids.

The particle stabilized emulsions can be water-in-oil (W/O) or oil-in-water (O/W) emulsions, or other emulsion forms. The well fluids of the present invention can comprise an aqueous brine (e.g., one or more alkali metal brine) in one of an external (continuous) phase and an inner (discontinuous) phase, wherein at least a portion of solid particles are arranged at an interface between the external and internal phases. W/O emulsions, or invert emulsions, are suited for many well applications, and therefore are sometimes used for illustration herein, but the present invention is not exclusively limited to that form of emulsion. The brine, for example, can be present in the inner (discontinuous) phase in invert emulsions of the present invention.

A “well fluid” can refer to any fluid adapted to be introduced into a well for any purpose. The well fluid can be a process fluid used as a well service fluid. A well fluid can be, for example, a well construction, operation, and/or maintenance (repair) fluid, such as a drilling fluid, completion fluid, low solids oil based mud (LSOBM), workover fluid, gravel packing fluid, fracturing fluid, packer fluid, and/or other fluid useful in drilling and/or well bore operations and/or completion operations for hydrocarbon recovery. For instance, the well fluid can be used in the drilling and/or completion of a well for hydrocarbon recovery such as oil and/or gas. The well fluid formulations of the present invention also can be used in other well construction and maintenance operations where fluids are pumped into the well bore to provide well control or services. According to various techniques in the industry, equipment, tools, and the well fluids can be directed from a wellhead into a desired portion of a wellbore. Additionally, the well fluid can be directed from a portion of a wellbore into rock matrix of a zone, such as a pay zone of a subterranean hydrocarbon-bearing formation.

Emulsions generally are colloidal systems that are mixtures of two or more immiscible liquids, where one liquid is dispersed in the form of droplets within a second immiscible liquid. Oil-water emulsions can be oil in water (O/W) where oil droplets are dispersed in water, which forms the continuous phase, or water-in-oil (W/O) emulsions where it is the oil that forms the continuous phase around water droplets, where “oil” denotes any suitable water-immiscible compound, and the “water” phase can be an aqueous salt solution. As indicated, the well fluids of the present invention can be based, for example, on internal aqueous/external hydrocarbon fluid emulsions (referred to herein as “inverts” or “invert emulsions”), or alternatively on oil in water emulsions. Emulsions are typically thermodynamically unstable and therefore require the dispersed phase droplets to be stabilized against coalescence by the adsorption of surface active species at the interface between the oil and the water. During coalescence, small droplets combine to form progressively larger ones. For a large part of industrial applications of emulsions, these surface active species are surfactants, polymers or proteins.

An emulsifier is a surfactant that stabilizes emulsions. Emulsifiers coat droplets within an emulsion and prevent them from coming together, or coalescing. In well fluids that use high density weighting components, such as cesium salts or other alkali metal brines, and which are exposed to the more rigorous downhole environments common to well fluids, it is found that surfactants may not provide a stable emulsion throughout preparation, handling, and usage.

A feature of the present invention includes use of emulsions in well fluids in which solid silica particles and/or other effective solid particles are used to stabilize emulsion droplets to provide well fluids that have greater stability than surfactant-based emulsions. As indicated, at least a portion of the solid particles are arranged at an interface between oil and aqueous phases of the emulsion to stabilize the emulsion. This approach can prepare higher stability LSOBMs or other well fluids that can provide benefit in at least two ways: (i) reduce loss of brine by providing a more stable LSOBM (particularly at elevated temperatures, e.g., 150-180° C.) and (ii) use denser brines, which can further conserve alkali metals, such as cesium. For example, a cesium phosphate brine solution has a much high density than a cesium formate brine solution. Cesium formate, for example, may reach a density of slightly above 1.6 g/cm³ when used in oil-based muds. Cesium phosphate can have a density, for example, of at least about 0.48 g/cm³ higher than cesium formate, and can produce weighting solids-free or weighting solids-reduced hydrocarbon-based muds (or fluids) that can have a density above about 2 g/cm³ or other values. Cesium phosphate brine having a density of up to about 2.7 g/cm³ (22.5 ppg) can be successfully used as an internal phase in oil-based muds, whereas cesium formate brine can have a density of up to about 2.3 g/cm³ (19.9 ppg) (at 20° C.). In view of this, in providing a targeted fluid density value for a well fluid, a higher density cesium salt such as cesium phosphate can be used in lesser amounts than needed for a lower density cesium salt such as cesium formate. As an example, approximately 22% (by weight) less cesium can be used to make 1.65 specific gravity (SG) LSOBM when cesium phosphate replaces cesium formate as the internal phase brine salt. However, in contrast to cesium formate, cesium phosphate can be formation damaging, which can deter its use in oil/gas production. High stability particle stabilized LSOBM and other well fluids of the present invention can be advantageous because it not only can mitigate salt loss downhole, such as by providing emulsions with increased temperature stability, but it further supports the use of cheaper and denser brines such as cesium phosphate in an internal phase, since the particle stabilized emulsions of the present invention can prevent contact between an internal phase containing cesium phosphate and oil-bearing rock formation.

Pickering emulsions refer to emulsions that are stabilized by fine solid particles only, in the absence of any other surface-active species such as surfactants, and/or polymers and/or proteins. The particle stabilized emulsions provided in the well fluids of the present invention can be Pickering emulsions. Pickering emulsions used in the present invention can be characterized by solid particles, such as solid silica particles, such as colloidal silica or fumed silica or other silica particles, which adsorb onto the interface between two immiscible liquid phases of a liquid/liquid emulsion. Generally, the phase that preferentially wets the particle will be the continuous phase in the emulsion system. The energy barrier for removal of particles from the interface is so high that particles can adsorb essentially irreversibly at the interface. When enough particles adsorb at an interface, they can become jammed and particle motion along the interface, e.g., oil water interface, is highly retarded. Since drop-drop coalescence would require particles to be displaced from the interfaces into one of the bulk phases, these emulsions can remain kinetically stable. As a result, particle stabilized emulsions can be more resistant to coalescence than those stabilized by surfactants, and the particle-stabilized emulsions can have significantly longer lifetimes than those stabilized by surfactants.

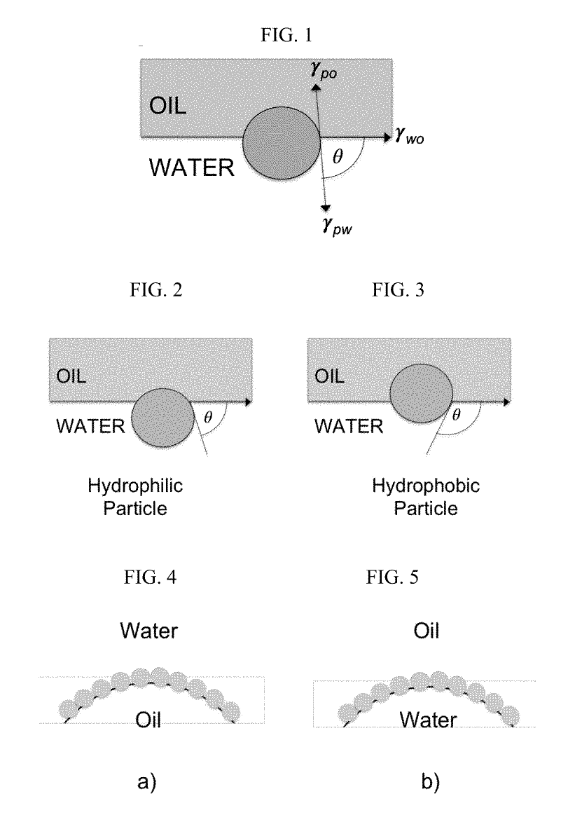

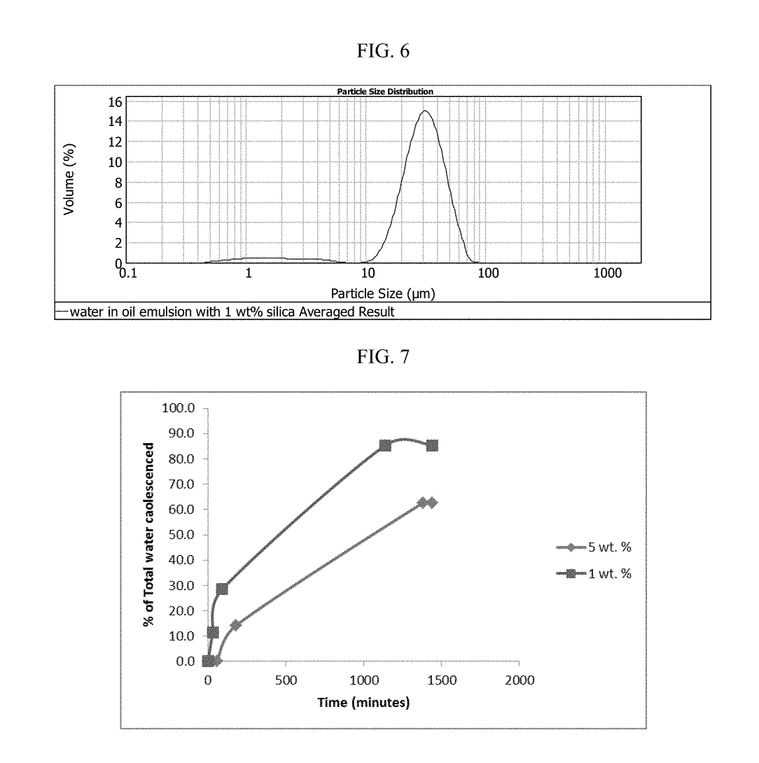

Parameters that can determine whether a solid particle is a good candidate for emulsifying the two liquid phases present in the system can include: i) the affinity of the particle for the interface, indicated by the ability of the particle, initially dispersed within one of the phases, to be wetted by the opposite phase in order to efficiently adsorb at the interface; ii) the size and shape of the particles, which influence the strength of adsorption of the particles at the interface; iii) the equilibrium position of the particle at the interface, where typically the largest proportion of its surface is in contact with the phase the particle was initially dispersed in and the rest of its surface (generally still a significant part) is in contact with the second phase. This equilibrium position can be characterized by the contact angle the particle adopts at the interface, which is always measured through the aqueous phase (see FIG. 1).

FIG. 1 is a schematic representation of the position of a solid particle at an oil-water interface and of the characteristic contact angle θ (measured through the water phase) adopted by the particle at the interface. The latter characteristic of a particle system determines how strongly adsorbed the particle is at the interface through an equation derived from the Young-Laplace equation (1) for the energy required to desorb a particle adsorbed at an interface: ΔG_{d}=πR²γ_{ow}(1±cos θ)², where ΔG_{d} is the energy required to desorb one particle from the interface, R is the radius of the particle, γ_{ow} is the interfacial tension between the oil and the water, θ is the contact angle measured through the water phase. Typically for particles of radii >20 nm and a contact angle in the range between 30-150°, the energy of desorption is equal to several kT and for contact angles (θ) closer to 90°, this can reach thousands of kT. This signifies that, under the right conditions, the thermal energy of the system is not sufficient to force the particles to desorb from these interfaces and that particle emulsifiers are kinetically trapped at the interface for significantly larger periods of time than their surfactants, polymers or proteins counter-parts. This is the reason for particle emulsifiers to be considered as irreversibly adsorbed at an oil-water interface and for the dramatically increased stability of Pickering emulsions as compared to emulsions stabilized by surfactants. Additionally, the position of the particle stabilisers at the oil-water interface influences the type of emulsions that are generated. Similarly to the fact that surfactant-stabilised emulsions can be formulated to be of an oil-in-water or water-in-oil type based on the characteristics of the surfactant (and typically through the use of concepts such as HLB and surfactant packing parameter and typically taken into account in the Bancroft rule), the type of Pickering emulsions produced can be predicted from the knowledge of the characteristic contact angle of the particle at the interface. For an oil to water ratio of 1:1, a contact angle <90° would tend to favor the formation of an oil-in-water emulsion and a contact angle >90° would tend to favor a water-in-oil emulsion. This is due to the preferential curvature of the interface during the emulsification stage, with the larger part of the particle volume packing more efficiently in contact with the continuous phase. FIGS. 2-5 illustrates this phenomenon. Schematics representing the behavior of particles as emulsifiers as a function of their contact angle for two particles with a different wettability for the interface resulting in different contact angles are shown in FIGS. 2 and 3, and the characteristic resulting emulsion types obtained when emulsifying a 1:1 oil:water system (by volume) are shown in FIGS. 4 and 5, respectively.

The emulsion stabilizing particles, such as silica particles, used in preparing the particle stabilized emulsions of the present invention can have a contact angle at the interface of less than 90°, as measured with respect to the aqueous phase, or can have a contact angle at the interface of greater than 90°, as measured with respect to the aqueous phase. Emulsion stabilization can be assessed in terms of the contact angle discussed above. “Stable” emulsions may have a contact angle from 60° to 120°, such as, for instance, 70° to 110°, e.g., from 75° to 105° or from 80° to 100°, or other angles. For invert emulsions, the particle stabilized emulsions of the present invention can have a contact angle at the interface of greater than 90°, as measured with respect to the aqueous phase, such as from 91° to 120°, or from 92° to 115°, or from 93° to 125°, or from 95° to 120°, or from 100° to 110°, or other obtuse angles.

It may be difficult to accurately measure the contact angle of the particle emulsifiers at the interface particularly for small particulates. In the absence of knowledge of the specific contact angle of the particles, one can design a series of experiments to test the type and stability of the emulsions produced with a specific particle emulsifier, particularly when oil-water ratios are likely to change for different formulations and when other surface active species are present in the system. A good starting point however is to choose a particle that disperses more efficiently in the aimed continuous phase of the emulsion (i.e. choosing an oil dispersible particle to obtain a water-in-oil Pickering emulsion) for the interface curvature reasons mentioned above.

With regard to comparing stability versus surfactant emulsions, some similarities can be present between surfactants and solid particles when used as emulsion stabilisers, such as both can generally behave in accordance with the Bancroft rule as explained above (with some typical exceptions), and the Hydrophilic-Hydrophobic Balance (HLB) of surfactants can be considered in a similar fashion to the contact angle value to predict the type of emulsion obtained for a system where both liquid phases are present as 50 vol %. However, there are some major differences that dictate the primary behavior of both sets of emulsions. These include that the energy associated with the desorption of surfactant molecules from the interface of interest is relatively low and can easily be overcome by the thermal energy, where in the case of solid particle emulsifiers, the energy of desorption is extremely large and typically hundreds of time above kT; the kinetics of adsorption of surfactants tend to be fast, while for solid particles, the much slower diffusion to the interface and associated slow absorption and adsorption into the interface is a much longer process; and this can give rise to a drastic difference in the kinetics of adsorption and desorption of surfactants and particles at interfaces and practically in the stability of emulsions stabilized by these species. In particular, particles tend to be considered as permanently adsorbed at the interface and therefore creating a strong physical barrier against droplet coalescence, while surfactants can desorb much more easily and on a very rapid timeframe, allowing potential droplet coalescence upon subtle changes in environmental conditions.

With regard to emulsion particle size, emulsions stabilized by solid particles can have a lower limit in diameter owing to the total surface area of a droplet needed to accommodate a certain number of particles to stabilize the system. This lower diameter is typically a function of the size of the solid particle emulsifiers used in the emulsification process. For solid-stabilised emulsions, this lower size limit typically can correspond to 5-10 times the diameter of the solid stabilizer.

With regard to required solid particle coverage, as indicated above, particles can act as emulsion stabilisers by preventing close approach of droplets through creating a physical barrier onto the droplet surfaces. Depending on the systems, a successful solid particle coverage for preventing droplet coalescence can range from as low as 30% (by area) to close to the full hexagonal packing number of a curved interface of ^{˜}70%. Very low particle densities can be provided where a polymer is used to bridge the solid particles when adsorbed at the interface. In such a case, the solid particles can create a two-dimensional (2D) particle ‘gel’ network (formed of fractal particle aggregates), which allows for a successful prevention of coalescence and overall long-term stability. However, high solid particle coverage does tend to ensure a better kinetic stability for the corresponding emulsions.

With regard to emulsions stabilized by a mixture of surfactants and particles, as indicated, the addition of surfactants to a suspension of solid particles, such as silica particles, to be used as emulsifiers for a system using brine, such as high density brine, is found to have antagonistic effects. Introduction of surfactant, as an option, only after the particle stabilized emulsion is made can be tolerated, which apparently does not disturb the coverage of brine droplets by the solid particles, such as silica particles.

The well fluids of the present invention comprise an emulsion that can contain at least hydrocarbon fluid (oil), an aqueous fluid, at least one salt, and solid particles (e.g., solid silica particles) as the emulsion stabilizing agent. The emulsion can be prepared in the complete absence of surfactant. For example, the composition used in preparing the particle stabilized emulsion can be free of surfactant, such as below measurable/detectible amounts, or trace or very small amounts may be present that do not impact the preparation of the particle stabilized emulsion such as total surfactant in amounts less than 2 wt %, or less than 1.5 wt %, or less than 1 wt %, or less than 0.5 wt %, or less than 0.1 wt %, or less than 0.01 wt %, or 0 wt % based on total weight of emulsion (all components).

Besides the hydrocarbon fluid (oil) and any optional ingredients, the remainder of the well fluid can be water or other aqueous solutions. Preferably, enough water is used to solubilize the salt(s) and form a brine fluid. The internal phase of the emulsion can comprise water in an amount of at least about 1%, or at least 3%, or at least 5%, or at least 10%, or at least 25%, or at least about 50%, or at least 75%, or at least about 90%, or at least about 95%, or at least about 99%, or from about 1% to about 99%, or from about 3% to about 95%, or from about 5% to about 90%, or from about 10% to about 80%, or from about 20% to about 70%, or from about 30% to about 60% by weight based on weight of the internal phase, or other values. The salt(s) used to form the brine can comprise from about 1% to about 99%, or from about 1% to about 80%, or from about 2% to about 95%, or from about 3% to about 90%, or from about 4% to about 80%, or from about 5% to about 75%, or from about 10% to about 70%, or from about 15% to about 65%, or from about 20% to about 60%, or from about 25% to about 55%, or from about 30% to about 50% by weight based on total weight of the internal phase. The internal phase of the particle stabilized emulsion of the well fluid can contain one or more salts, such as a cesium salt and/or other alkali metal salt, that has a density of from about 1.01 g/cm³ to about 2.75 g/cm³, or from about 1.25 g/cm³ to about 2.75 g/cm³, or from about 1.50 g/cm³ to about 2.75 g/cm³, or from about 1.60 g/cm³ to about 2.75 g/cm³, or from about 1.75 g/cm³ to about 2.75 g/cm³, or from about 2.00 g/cm³ to about 2.75 g/cm³, or from about 2.25 g/cm³ to about 2.75 g/cm³, or other densities. Conventional ingredients used in well fluids may also be used with the well fluids of the present invention, though surfactants should not be introduced during preparation of the particle stabilized emulsion that degrade the stability of the particle stabilized emulsion.

The well fluid, such as a drilling fluid, LSOBM, completion fluid, workover fluid or packer fluid, can contain a single kind of salt (e.g., a cesium salt) or blends of two or more salts, such as two or more different alkali metal salts, wherein preferably one of the alkali metal salts is a cesium salt. As indicated, the alkali metals used in the salts can be cesium, sodium, potassium, rubidium or other alkali metals. These alkali metals can form water soluble salts or double salts with formates, phosphates, acetates, carbonates, halides, oxides, nitrates, sulfates, or other anionic moieties.

Alkali metal formates are commercially available. For instance, cesium formate can be obtained from Cabot Corporation. The cesium formate can be made, for instance, by following the description as set forth in International Published Patent Application No. WO 96/31435, incorporated in its entirety by reference herein. The cesium formate that is present in the well fluid, preferably as a soluble salt, can be present in any concentration and the cesium formate solution is a liquid at room temperature. The concentration of cesium formate in well fluids, such as LSOBM, can be from about 1% to about 100% by weight, and more preferably is present in an amount of from about 40% to about 95% by weight, and even more preferably is present in the well fluid at a range of from about 55% to about 85% by weight or is present in the well fluid at a range of from about 70% to about 85% by weight based on the weight of the well fluid. Other alkali metal formates that can be used alternatively or in addition, in the present invention are potassium formate and/or sodium formate which are commercially available. These alkali metal formates can also be prepared in a similar fashion as the cesium formate solution described above.

As an option, a brine can be prepared and solid particles such as nanoparticles (e.g., having an average particle size of 1 nm to 500 nm) can be added to the brine to densify the brine and then the same particles that are present in the brine to densify the brine or for other reasons can then be subjected to the pickering process to prepare the pickering emulsion.

As indicated, very high density brines can be formed, for instance with cesium, such as cesium phosphate brine, which can be used in the well fluids of the present invention. A water-based cesium phosphate solution, or its blend with a different kind of alkali metal phosphate such as potassium phosphate solution, is designed to be a fluid under common handling and drilling conditions. For example, the cesium phosphate-based brine, or its blend with another alkali metal phosphate brine, can be stably maintained in the internal phase of the particle stabilized emulsion of a well fluid that is used before, during and/or after drilling operations. Since the cesium phosphate-containing brine, or its blend with another alkali metal phosphate brine, can be used and maintained in the internal phase of the particle stabilized well fluids, corrosion, and/or formation damage problems can be reduced or avoided. Further, the particle stabilized emulsions of well fluids of the present invention can be conveniently and economically prepared in solids-free or low solids formats with accessible emulsification methods, such as sonic vibration, a high shear mixer, homogenization, or microfluidization, with reduced or avoided concerns about dealing with hard or gritty solid particulate contents.

As used herein, “cesium phosphate” can refer, for example, to any of cesium dihydrogen phosphate, cesium monohydrogen phosphate, cesium dihydrogen pyrophosphate, tricesium phosphate, or any blends thereof. Illustrative empirical formulas which are used for these forms of cesium phosphate are, for example, CsH₂PO₄, Cs₂HPO₄, Cs₂H₂P₂O₂, and Cs₃PO₄, respectively. These forms of cesium phosphate can be used individually or blended in any ratios. As an option, the “cesium phosphate” can be a blend, for example, of cesium dihydrogen phosphate and cesium monohydrogen phosphate, in any blending ratios thereof. In aqueous solutions or brines, cesium phosphate salts can dissociate, for example, into Cs⁺ cations and phosphate anions.

Cesium phosphate can be synthesized, for example, by known methods. Cesium phosphate can be synthesized, for example, using known acid-base neutralization reactions between an alkali metal hydroxide solution, a cesium hydroxide (CsOH) solution in this instance, and a strong acid, such as orthophosphoric acid (H₃PO₄). Cesium metal is a liquid at or near room temperature, and is highly reactive with air (oxygen), moisture, and cold water. As generally known, cesium metal can react vigorously with water to form a colorless solution of cesium hydroxide (CsOH) and hydrogen gas. Cesium hydroxide monohydrate (CsOH.H₂O) also is commercially available, which, as known, can be dissolved in distilled water to provide a CsOH solution. The CsOH solutions are strongly basic because of the dissolved hydroxide. A cesium hydroxide solution can be reacted with a dilute phosphoric acid (e.g., about 3N) to produce cesium phosphate products and water. This reaction is illustrated, for example, by the following equation wherein the reactants are used in equimolar amounts:

CsOH_{(aq.)}+H₃PO_{4(aq.)}→CsH₂PO_{4(aq.)}+H₂O₍ₗ₎.

Cesium monohydrogen phosphate (Cs₂HPO₄) can be produced, for example, by adjusting the above reaction wherein a molar excess of the cesium hydroxide is used for at least part of the reaction. These brine products may be used as is, or may be recovered and isolated as crystalline material and redissolved in water when desired to form brines for use in the well fluids of the present invention. Cesium dihydrogen pyrophosphate (Cs₂H₂P₂O₂) can be produced by dissolving cesium pyrophosphate (e.g., produced by igniting cesium monohydrogen phosphate) in a solution of glacial acetic acid in water, and heating the solution with stirring and then cooling to precipitate cesium dihydrogen pyrophosphate product. These precipitated products can be recovered and used for brine preparation when desired. The method of synthesis of cesium phosphates suitable for use in well fluids of the present invention is not limited to any particular reaction pathway. Cesium phosphates can be commercially obtained.

A cesium salt brine can be used alone or blended with other brines in the well fluids of the present invention. The cesium phosphate brine, for example, can be blended with at least one different brine (e.g., one or more alkali metal salts) to adjust density or for other reasons. The different brine can be, for example, a halide brine, metal acetate, a different alkali metal brine, e.g., a different alkali metal phosphate, or an alkali metal monocarboxylate, or an alkali metal tungstate, or any combinations thereof. Salts of the alkali metals typically are readily soluble in water other than lithium salts. The different brine from cesium phosphate can include one or more alkali metal compounds, for example, cesium formate, cesium acetate, potassium formate, sodium formate, potassium phosphate, sodium phosphate, rubidium phosphate, and/or cesium tungstate, or any combinations thereof. The blending ratios of these brines including cesium phosphate are not particularly limited. A blend of brines which includes cesium phosphate can provide a combined brine which can remain stable in an invert emulsion and which can have a suitable overall density or other performance-related property for the drilling operations. Combinations of different brines which include cesium phosphate may be used to “dial in” various densities in the well fluids.

As stated, cesium phosphate can be water-soluble and can form very high density brines. When used to produce an internal aqueous phase of the well fluids, the cesium phosphate concentration can be, for example, any value up to full saturation. The upper limit of the cesium phosphate salt component in the brines can be dependent in part upon the solubility of the cesium phosphate in water. The cesium phosphate brine can be less than fully saturated in the well fluid. The internal phase of the particle stabilized emulsion of the well fluid can contain the cesium phosphate in an amount of at least about 5% by weight, or at least about 10% by weight, or at least about 20% by weight, or at least about 30% by weight, or at least about 40% by weight, or at least 50% by weight, or at least 60% by weight, or at least 70% by weight, or from about 10% to about 99% by weight, or from about 20% to about 97.5% by weight, or from about 30% to about 95% by weight, or from about 40% to about 90% by weight, or from about 50% to about 85% by weight, or from about 60% to about 80% by weight, or other amounts, based on the total weight of the internal phase.

Depending on the particular drilling or other well operation, and reasons of emulsion stability, economy, and other factors, a cesium phosphate-containing inner aqueous phase of the particle-stabilized emulsion of the well fluid can comprise, for example, from about 99% by weight to about 1% by weight cesium phosphate (on a solids basis) and from about 1% by weight to about 99% by weight water, or from about 95% by weight to about 10% by weight cesium phosphate (on a solids basis) and from about from about 5% by weight to about 90% by weight water, or from about 85% by weight to about 20% by weight cesium phosphate (on a solids basis) and from about 15% by weight to about 80% by weight water, or from about 80% by weight to about 40% by weight cesium phosphate (on a solids basis) and from about 20% by weight to about 60% by weight water, or from about 80% by weight to about 60% by weight cesium phosphate (on a solids basis) and from about 20% by weight to about 40% by weight water, or other amounts.

Cesium phosphate brines can be provided, for example, which have a density of at least about 1.9 g/cm³, or at least about 2.0 g/cm³, or at least about 2.1 g/cm³, or at least about 2.2 g/cm³, or at least about 2.3 g/cm³, or at least about 2.4 g/cm³, or at least about 2.5 g/cm³, or at least about 2.6 g/cm³, or at least about 2.65 g/cm³, or from about 1.9 g/cm³ to about 2.75 g/cm³, or from about 2.0 g/cm³ to about 2.7 g/cm³, or from about 2.05 g/cm³ to about 2.68 g/cm³, or from about 2.1 g/cm³ to about 2.65 g/cm³, or from about 2.2 g/cm³ to about 2.6 g/cm³, or from about 2.3 g/cm³ to about 2.5 g/cm³, or other density values. These densities may apply to brine combinations of cesium phosphate with other metal salts.

In general, although the internal phase of the particle stabilized emulsion of the well fluid is shown to include salts and water, the internal phase is not necessarily limited to internal aqueous phases, provided that a fluid medium used for salts and any other components of the internal phase which can be emulsified with hydrocarbon fluid, such as to provide invert emulsions, wherein the salts can be substantially or completely contained in an internal (discontinuous) phase of the resulting particle stabilized multi-phase well fluid.

The external phase of the particle stabilized emulsion of the well fluids can comprise a base oil and/or other hydrocarbon fluids which impart similar properties in the well fluids. The hydrocarbon fluid can be, for example, an oleaginous base oil. The hydrocarbon fluid can be a material that is immiscible or essentially immiscible with aqueous brines, such as cesium brines, absent emulsification. Examples of the hydrocarbon fluids include, but are not limited to, diesel oil such as diesel oil number 2, mineral oils, crude oil, kerosene, as well as other conventional hydrocarbon fluids. Hydrocarbon fluids used in conventional oil based muds can be used as the external phase of the particle stabilized emulsions of well fluids of the present invention. Synthetic fluids, such as those used in conventional SBMs, also can be used as the external phase material of the particle stabilized emulsions of well fluids of the present invention. Conventional synthetic fluids which can be used include, for example, ethers, esters, olefin oligomers, or blends of these materials. The synthetic fluids can be, for example, (a) esters, which are synthetic oil soluble liquids made by the reaction of a fatty acid (e.g., a vegetable fatty acid) with an alcohol; (b) ethers and polyethers, such as a mono-ether, di-ether or mixture made by condensation and partial oxidation of alcohols; (c) paraffinic hydrocarbons, such as poly-alpha-olefins which are straight chain non-aromatic hydrocarbons which typically are made by polymerization of ethylene; (d) detergent alkylate which is also called a linear alkyl benzene, which is benzene to which a saturated hydrocarbon has been attached, and (e) mixtures of these synthetic hydrocarbon fluids. More specifically, the synthetic fluids can comprise, for example, synthetic oils (such as paraffin oils, olefin oils, vegetable oils, and the like). A non-limiting example of synthetic oil which can be used is IA-35 from Integrity Industries. These synthetic fluids are oil-soluble and normally highly lubricious and can have many of the characteristics of the indicated oils used in conventional OBMs. As will be apparent, this invention can be used in oil-based muds (OBM's), such as low solids oil based muds (LSOBM's), and muds having these synthetic bases (SBM's), which are referred to herein as drilling fluids or muds. Here, “oil based” is the external phase. Combinations of various oil based fluids or synthetic mud fluids also can be used for the hydrocarbon fluids forming the external phase of the particle stabilized emulsions of the well fluids of the present invention.

The well fluids can cover all water concentrations wherein an external hydrocarbon phase and internal aqueous phase which contains one or more salts (e.g., cesium salt and/or other alkali metal salt) can be provided. Various ratios of the hydrocarbon fluid to the aqueous-based solution described above can be used, for example, such as ratios of from about 99% by volume hydrocarbon fluid: about 1% aqueous based solution to about 1% by volume hydrocarbon fluid: about 99% by volume aqueous based solution; or from about 95% by volume hydrocarbon fluid: about 5% aqueous based solution to about 60% by volume hydrocarbon fluid: about 40% by volume aqueous based solution; or from about 90% by volume hydrocarbon fluid: about 10% aqueous based solution to about 55% by volume hydrocarbon fluid: about 45% by volume aqueous based solution, or other ratios. More specifically, well fluids, such as drilling fluids and muds made with these hydrocarbon fluids and cesium phosphate-containing brines can be particle stabilized inverted emulsions, for example, which contain water (all sources) from about 1% to about 50% by volume, or from about 3% to about 40% by volume, or from about 5% to about 20% by volume, or other volumes, based on the total volume of the well fluid. As stated, the water can form an aqueous-based solution which contains the salt(s) (e.g., cesium and/or other alkali metal salt) as an internal (discontinuous) phase in the hydrocarbon fluid forming an external phase of the particle stabilized inverted emulsion.

As stated, the salt(s) can be at least partially or totally emulsified as an internal phase of the particle stabilized emulsion of the well fluid. The internal phase of the well fluid can contain, for instance, at least about 75% by weight, or at least about 90% by weight, or at least about 95% by weight, or at least about 97.5% by weight, or at least about 99% by weight, up to 100% by weight of the total amount of salt present in the well fluid. For instance, the cesium phosphate can be present in the well fluid in an amount of from about 1% to about 99% by weight, or from about 5% to about 95% by weight, or from about 10% to about 90% by weight, or from about 15% to about 85% by weight, or from about 25% to about 80% by weight, or from about 30% to about 75% by weight, or from about 40% to about 70% by weight, or other amounts, based on the total weight of the well fluid.

As indicated, the solid stabilizing particle used to stabilize the emulsion can be a solid silica particle and/or other solid particle having similar effect as described herein.

When silica is utilized as the solid stabilizing particle, fumed silica particles, colloidal silica particles, precipitated silica, and/or other silica particles can be used. The silica particles can be amorphous particles, silica composite particles, multiphase particles including a silica phase, or other kinds of silica containing particles, which have the stabilizing effect at the interface of the hydrocarbon fluid and aqueous brine phases.

The silica particles (or solid particles in general) can have a size of from 1 nm to 500 nm, or from 2 nm to 300 nm, or from 3 nm to 275 nm, or from 5 nm to 250 nm, or from 10 nm to 200 nm, or from 20 nm to 150 nm, or from 50 nm to 125 nm, or from 90 nm to 110 nm, or other values. Particle size measurements for silica particles or other solid particles described herein can be made with a Malvern Mastersizer 2000. The solid particles can be spherical or non-spherical. The silica particles and/or other emulsion stabilizing particles can be contained in the emulsion in an amount of from about 1 wt % to 30 wt %, or from 5 wt % to 20 wt %, or from 8 wt % to 15 wt %, or other amounts, based on overall weight of the particle stabilized emulsion or well fluid.

Fumed silica, also known as pyrogenic silica, are microscopic droplets of amorphous silica fused into branched, chainlike, three-dimensional secondary particles which then agglomerate into tertiary particles. The resulting powder has an extremely low bulk density and high surface area. The fumed silica can be composed of spherical primary particles of 5-50 nm in size, which can be 40-60% fused into short chains, very highly branched. The spheres can be quite uniform in size for a given product, but the chain lengths can be quite variable, e.g., 10 to 30 units in length or more. As the aggregates cool down below the fusion temperature of silica, further collisions result in some reversible mechanical entanglement or agglomeration. Further agglomeration occurs during the collection process; this can be reversed by proper dispersion in a suitable medium. Sizes of fumed silica, such as aggregates (secondary particles) of fumed silica, can include the above indicated sizes for silica particles. The fumed silica can be used in the above amounts indicated generally for the silica particles.

Colloidal silicas are suspensions of fine amorphous, nonporous, and typically spherical silica particles in a liquid phase. Colloidal silicas are most often prepared in a multi-step process where an alkali-silicate solution is partially neutralized, leading to the formation of silica nuclei. The subunits of colloidal silica particles are typically in the range of 1 to 5 nm. Whether or not these subunits are joined together depends on the conditions of polymerization. The colloidal suspension is stabilized by pH adjustment and then concentrated, usually by evaporation. The maximum concentration obtainable depends on the particle size. For example, 50 nm particles can be concentrated to greater than 50 wt % solids while 10 nm particles can only be concentrated to approximately 30 wt % solids. Sizes of colloidal silica which can be used can include the above indicated sizes for silica particles. Colloidal silica also may be used in smaller sizes, such from 1 nm to 150 nm, or from 2 nm to 100 nm, or from 5 nm to 90 nm, or from 10 nm to 75 nm, or other values. The colloidal silica can be used in the above addition amounts indicated generally for the silica particles.

Untreated (unmodified) fumed or colloidal silica particles, which typically are hydrophilic, may be less effective for stabilizing W/O emulsions of the present invention. Hydrophobic modified silica particles can be preferred for providing longer term emulsion stability. Hydrophobic modified fumed silica is commercially available, such as Aerosil® R974 (Evonik), and TS 622, TS 530, and TS 382 (Cabot Corporation). Hydrophobic modified colloidal silica is commercial available, such as Cab-o-sil® TG-C390 and Cab-o-sil® TG-C413 (Cabot Corporation). Specific examples of hydrophobic modified silica particles can utilize partially treated silica particles which are interfacially active (i.e. they will spontaneously arrange themselves at the water-oil interface and thus stabilize the emulsion). Untreated silica particles can be treated with an agent that associates with or covalently attaches to the silica surface, e.g., to add some hydrophobic characteristics. Silica treating agents can be any suitable silica treating agent and can be covalently bonded to the surface of the silica particles or can be present as a non-covalently bonded coating. Typically, the silica treating agent is bonded either covalently or non-covalently to silica. The silica treating agent can be a silicone fluid, for example, a non functionalized silicone fluid or a functionalized silicone fluid, hydrophobizing silanes, functionalized silanes, silazanes or other silica treating agents. Alkylhalosilanes, alkoxysilanes, and silazanes preferably can be used as silica treating agents. An example of the alkylhalosilanes is dimethyldichlorosilane. An example of the alkoxysilanes is trimethoxyoctylsilane, and an example of the silazanes is hexamethyldisalizane. Examples of alkoxysilanes and silazanes suitable for treating fumed silicas or colloidal silicas also are described in U.S. Patent Application Publication No. 2008/0070146 to Fomitchev et al., published on Mar. 20, 2008, incorporated herein by reference in its entirety. U.S. Pat. No. 7,811,540 to Adams and incorporated herein by reference in its entirety, describes silyl amines that can be utilized in treating fumed silanes or colloidal silicas. The silica-treating agent can comprise a charge modifying agent such as one or more of those disclosed in U.S. Patent Application Publication 2010/0009280 to Liu et al., the contents of which are incorporated herein by reference. Alternatively or in addition, the dimethylsiloxane co-polymers disclosed in U.S. Patent Application Publication No. 2011/0244382 A1 to Christopher, the content of which is incorporated herein by reference in its entirety, may be used to treat silica particles. At least partial treatment of particulate silica also can be obtained by using polydimethylsiloxane (PDMS) and the like, as described, for instance, in U.S. Pat. No. 6,503,676 to Yamashita, et al., which is incorporated herein by reference in its entirety.

As an option, in addition to the internal brine phase and hydrocarbon fluid of the external phase, the particle stabilized emulsion of the well fluid may include one or more other ingredients that optionally can be present, such as non-emulsifying solid particles, such as non-emulsifying non-clay solid particles, clays, organoclays, polymer(s) to add to viscosity, hydrophilic clays, fluid loss control additives, amine-treated clays, and/or clays treated such that they provide viscosity in non-aqueous fluids, and the like.

Optional non-emulsifying solid particles can be used in the emulsion for functions that at least in part do not involve stabilizing of the interface of the emulsion phases, provided that they do not disrupt or interfere with the stabilizing particles used in forming and maintaining the Pickering emulsion. In one example, the non-emulsifying solid particles, if included, can be carbon-based particles (such as carbon black, surface-modified carbon black, amorphous carbon such as expanded graphite, fullerenes, carbon nanotubes, activated carbon and other types of carbon-based particles), clays (e.g., bentonite), aluminas, titania, zirconia, ceria, palladium, tin oxide, magnesium aluminum silicate, magnesium oxide, any combination thereof, and/or other suitable solid particulate materials. These non-emulsifying particles and mixtures thereof may be used to modify the rheology of the well fluid and/or for other purposes. Amounts of non-emulsifying particles, if used, can vary. The non-emulsifying solid particle(s), if used, can be present in the blend in minor amounts, i.e., less than 50 wt %, e.g., within the range of from about 1 wt % to about 49 wt %, or from about 2 wt % to about 45 wt %, or from about 3 wt % to about 40 wt %, or from about 5 wt % to about 30 wt %, or from about 10 wt % to about 25 wt % by total weight of solid particles in the emulsion.

An example of organoclay that can be used is an organophilic clay such as Bentone® products (Element's Specialites), e.g., Bentone® 38. Bentone® is not naturally occurring. It is manufactured by chemically modifying naturally occurring clays like bentonite (a naturally occurring hydrophilic clay), so that they become organophilic, i.e., they have a strong affinity for organic compounds like those found in oil. A clay, such as an organoclay can be used as a rheology modifier for the oil phase or other functions. The organoclay, e.g., Bentone® organoclay, can be included in the emulsion in an amount of from about 0.5 wt % to 10 wt %, or from 1 wt % to 8 wt %, or from 2 wt % to 6 wt %, or from 3 wt % to 5 wt %, or other amounts, based on overall weight of the particle stabilized emulsion. For organoclay to act as a rheology modifier for oils to which colloidal silica is or will be added, a surfactant, e.g., a KemVert™ surfactant(s) (Kemira) can be also used. As shown in the examples herein, the timing of the addition of a surfactant can be managed such that the addition of the surfactant to the well fluid preferably is delayed until after the particle stabilized emulsion has been prepared, and this is desired even when an organoclay has already been introduced into the emulsion forming composition prior to emulsification. As an option, fumed silica can self-act as a rheology modifier in oil, as an option, no organoclay and hence no surfactant, are used.

Other clays that may be used are bentonite, hectorite, and/or other clays. These other optional ingredients can be used in amounts sufficient for their purposes, provided that they do not destabilize the emulsion.

Water insoluble weighting materials, such as those described above, may be included.

As indicated, surfactants are undesired and not preferred in the preparation of the emulsion since they can degrade the stability of the particle stabilized emulsion. The well fluid can contain a solid weighting material. Other ingredients used in oil-based or synthetic-based well fluids optionally can be used with the well fluid or muds of the present invention. Besides the optional ingredients, the remainder of the well fluid can be water or other aqueous solutions. The majority of the water or other aqueous solution can form part of the internal phase of the well fluid. For example, at least 50%, or at least 75%, or at least 90%, or at least 95%, or at least 98%, or at least 99% by weight or volume of the total water in the well fluid can be present in the internal phase thereof.

As indicated, surfactants, if used, preferably are added after a particle stabilized emulsion has already been prepared. The particle stabilized emulsions, once prepared, can better tolerate the subsequent co-presence of surfactants in a common well fluid composition. The surfactant(s), if used, can be a nonionic surfactant, an anionic surfactant, or a cationic surfactant. Nonionic surfactants, if used, can be, for example, Synperonic A3 (Croda), C12E06 (Syngenta), or Span® 80 (Sigma Aldrich). As indicated, a surfactant (e.g., KemVert™ surfactants (Kemira)) also may be used, such as KemVert™ 1899 and/or KemVert™ 1764, such as in the cases, as indicated, where clay, such as an organoclay (e.g., Bentone®) is used in the preparation of the emulsion as a rheology modifier. Other examples of surfactant(s), if used, for example, can be a dimer trimer acid, imadazoline, tall oil, or combinations thereof. Examples include, but are not limited to, dimer trimer acid such as Witco DTA 350, imadazoline, tall oil (stearic acid), Integrity Synvert IV, Integrity Synvert TWA, and the like. Amounts of surfactant which can be used in the well fluid are, for example, from about 1 to about 30 pounds surfactant per barrel, or from about 3 to about 25 pounds surfactant per barrel, from about 5 to about 20 pounds surfactant per barrel, or other amounts, wherein a barrel is about 42 gallons, provided that it does not destabilize or break the particle stabilized emulsion.

Other optional ingredients that can be present in the well fluids of the present invention include, for example, a filtration control agent and/or pore bridging materials, such as Gilsonite, and the like. These filtration control agents can be used in conventional amounts.

Other ingredients that can be present in well fluids of the present invention include solid weighting materials such as barite, hematite, and/or calcium carbonate. Calcium carbonate can be commercially obtained, for example, as Baroid Baracarb 50. These solid weighting materials can be used if desired. The amount of solid weighting material, which is optional, can be from about 0.5 pound per barrel to about 500 pounds per barrel.

The cesium phosphate or other cesium salt or alkali metal salt that can be present as part of the aqueous-based solution of the internal phase can be present at less than full saturation (e.g., below an amount that causes the salt to fall out of solution) in the aqueous-based solution so as to permit any remaining water-soluble components to preferably solubilize in the solution along with the cesium phosphate. Thus, cesium phosphate, for example, can be present in the aqueous-based solution of the internal phase, for example, in an amount of less than 80% by weight, based on the aqueous-based solution basis, and can be, for example, from about 60% to about 80% by weight, based on the aqueous-based solution basis.

Well fluids based on the particle stabilized emulsions of the present invention can have good thermal stability for conditions commonly encountered by well fluids. The well fluids can be stable up to at least 100° C., or at least 150° C., or at least 200° C., or other values. The particle stabilized emulsion can be stable up to at least 180° C. for 48 hours, or up to at least 190° C. for 48 hours, up to at least 200° C. for 48 hours, or up to at least 180° C. for 60 hours, or other temperature and duration combinations.

Another advantage of the present invention can be the ability for the density of the well fluid to be adjusted to a desired density. As stated, this can especially be done with the introduction of a combination salts, for example, of cesium phosphate with a different metal salt, such as potassium phosphate. As an example, an aqueous-based internal phase portion of the particle stabilized emulsion of the well fluid can contain cesium phosphate, which, as stated, can have a density of from about 1.01 g/cm³ to about 2.75 g/cm³, or from about 2.25 g/cm³ to about 2.75 g/cm³, or other densities. This density range can be adjusted, for example, with the introduction of potassium phosphate or other lower density alkali phosphate or other metal salt, such as a water soluble lower density alkali metal phosphate. As an option, the combination of cesium phosphate with an alkali salt having a lower density results in a combination brine having a density lower than that of cesium phosphate, and which may provide an overall brine density, for example, that is between the densities of the individual component salts. For instance, when 0 to 100% by weight of potassium phosphate is included in the aqueous-based internal phase portion of the well fluid, such as in combination with cesium phosphate, the density of the overall aqueous-based portion of the well fluid can range, for example, from about 1.01 g/cm³ to about 2.75 g/cm³, or other values, such as depending on the relative proportions of the constituent brines. Thus, the density of the well fluid can essentially be “dialed-in” to meet the density needed for the well fluid to be used in the drilling of or other operation in a well bore at the appropriate depths. For lower density ranges, sodium phosphate can be added to the cesium phosphate, hence, “dialing-in” lower density well fluids. Thus, the well fluids of the present invention also make it possible to achieve a variety of different densities and to minimize or completely eliminate the solid weighting material that is present in conventional drilling fluids.

The well fluids of the present invention can be introduced into the well bore by any conventional technique such as, but not limited to, being pumped into the drill pipe. Further, the well fluids can be recovered using conventional techniques.

The well fluids of the present invention can be prepared by mixing the solid particles and the hydrocarbon fluid (“oil”) to disperse the solid particles in the hydrocarbon fluid to form a dispersion. An aqueous brine (e.g., alkali metal brine) then can be added to the dispersion of the solid particles in the hydrocarbon fluid to form a mixture. The mixture of hydrocarbon fluid, solid particles and aqueous brine can be emulsified to form an emulsion comprising a first phase comprising hydrocarbon fluid, and a second phase comprising an aqueous brine (e.g., alkali metal brine), wherein at least a portion of the solid particles are arranged at an interface between the first phase and the second phase to provide a stabilized emulsion. Optional rheology modifier additive, and/or other additives other than surfactant, can be added to the hydrocarbon fluid in the preparation of the dispersion before addition of the aqueous brine.

As indicated, where the solid particles are colloidal silica, for example, a rheology modifier may be used, which can more easily permit the inclusion of a surfactant, such as a KemVert™ surfactant. As indicated, the surfactant preferably is not introduced until after preparation of the particle stabilized emulsion so as not to risk thermal stability degradation or breaking of the emulsion. Optional additives also may be added during or after the preparation of the particle stabilized emulsion, provided that they do not disrupt the emulsion and demulsify the composition. The first phase of the emulsion can be an external phase comprising the hydrocarbon fluid and the second phase can be an internal phase comprising aqueous brine dispersed in the hydrocarbon fluid. The relative amounts of the hydrocarbon fluid and aqueous brine phase can be selected to encourage formation of a W/O emulsion or invert emulsion wherein the aqueous brine forms the internal discontinuous phase in a continuous phase of hydrocarbon fluid, such as by using relatively larger amount of hydrocarbon fluid than aqueous brine.

In a particle stabilized emulsion, saturation typically occurs when the surface of the immiscible droplet (e.g., the aqueous brine droplet in a W/O emulsion) is completely covered with solid particles. Pickering emulsions may be formed by using the minimum amount of particles necessary to stabilize the emulsion. Using low particle loadings can minimize possible contamination or burden introduced into a system by the stabilizing particles, lessening recovery or purification requirements. As used herein, the term “low particle loading” refers to emulsions that utilize less that the saturation amounts, where the saturation amount is the amount of stabilizing particles needed to generate one monolayer around the droplet. In some cases, just a few particles around a droplet having a surface mostly uncovered by stabilizing particles may be sufficient to produce a stabilized emulsion. For instance, emulsions having low particle loadings may contain silica in an amount of less than 5% by weight of the water phase of the emulsion. The emulsion can form spherical droplets (also referred to as drops).

The emulsifying can comprise mechanical mixing with sonic vibration, a high shear mixer, homogenization, microfluidization, or other emulsification methods/equipment. When an emulsion is prepared, typically, the components can be mixed together such as by shearing in order to ensure a dispersion that is preferably uniform with respect to the components. A static or in-line high shear mixer, sonic probe, or homogenizer, for example, can be used to emulsify the components of the well fluid to form an external phase comprising the hydrocarbon fluid and an internal phase containing the water and water soluble components including the salt(s) that form the brine. High shear mixers generally are known and commercially available for emulsification of hydrocarbon oils and brines, which can be adapted to prepare the invert emulsions of the well fluids of the present invention. As an option, a commercial high shear mixer that may be used can be, for example, a Silverson high shear/emulsifier rotor/stator type mixer, such as a Silverson High Shear In-line mixer used on a recirculation basis or a modified Silverson Flashblend mixing system (Silverson Machines, Inc., East Longmeadow, Mass., U.S.A.). A commercially available homogenizer that can be used for emulsification is an IKA T18 Ultra Turrax (IKA). A commercially available ultrasonic probe that can be used for emulsification is a Hielscher UP2005 (Hielscher Ultrasonics GmbH).

After blending, with the present invention, the viscosity of the well fluid can be reduced. For instance, the viscosity can be reduced 20% or more, 15% or more, 10% or more, or from 5% to 15% or from 5% to 20%, compared to the starting viscosity of the well fluid. The emulsion can be a flowable fluid or thicker, e.g., gel-like. The particle stabilized emulsions can be observed using known analytical techniques, such as using an optical micrograph image. The particle stabilized emulsions described herein may be formed to have a droplet average diameter within the range of from about 0.5 micron to about 300 microns, for example from about 10 microns to about 250 or to about 200 or to about 180 or to about 160 microns, e.g., of from about 20 microns to about 150 microns. The droplet average diameter can be within the range of from about 30 microns to about 120 microns of from about 40 microns to about 120 microns. In other cases, the droplet average diameter can be within the range of from about 50 microns to about 75 microns, or to about 80 microns, or to about 90 microns or to about 100 microns. The droplets can have a diameter of from about 1 micron to about 100 microns. Whether the emulsion is an O/W rather than W/O emulsion can be determined by adding a water-soluble dye and determining whether the dye is visible in the continuous phase. Other suitable techniques also can be employed.

A mineral oil, such as Clairsol 370 (Petrochem Carless Ltd., Surrey England), and a cesium phosphate solution having a density of at least about 1.9 g/cm³, when combined in a weight ratio of 1:1 and by addition of the silica particles admixed by shearing or sonication, can produce an emulsion or microemulsion that has a cesium phosphate-containing invert phase or (internal phase) and an oil external phase, wherein the silica particles are practically irreversibly adsorbed at the brine/oil interface. The density of the combined mixture of this example can be suitable for drilling operations and/or completion fluids, or other well fluids.

Optionally, well fluids or muds of the present invention can contain at least one acid. The acid can be, for example, a water soluble acid containing at least one carboxylic group, such as a formic acid or an acid derivative thereof. Other examples of acids that can be used include, but are not limited to, acetic acid, ascorbic acid, citric acid, tartaric acid, phthalic acid, glycolic acid, and combinations thereof. The acid can be present in various amounts such as from about 1% by weight or less to about 25% by weight or more based on the weight of the well fluid, such as a drilling fluid. The presence of the acid has the capability of adjusting the pH of the well fluid as well as providing other benefits to the well fluid. When an acid is present, for instance, the cesium phosphate can be present in any molar amount, such as an amount of about 3 M. Similarly, the acid, when present, can be present in any molar amount, and can be present, for example, in an amount of from about 2.2 M to about 15 M. The pH of the well fluid can be adjusted as desired or needed.

The present invention will be further clarified by the following examples, which are intended to be only exemplary of the present invention. Unless indicated otherwise, all amounts, percentages, ratios and the like used herein are by weight.

### EXAMPLES

Methods and Materials

### Equipment

### Homogenizer—IKA T18 Ultra Turrax

Ultrasonic probe—Hielscher UP200S
Particle size measurement—Malvern Mastersizer 2000 with Hydro uP dispersion cell

### Dispersion Analyser—LUMISizer

### Microscope—Olympus BX51

Cryogenic SEM-FEI Quanta 200F FEG ESEM with quorum technologies (Polaron Range) polar prep 2000 cryo transfer system

### Materials

Fumed silica: Aerosil® R97 (Evonik); from Cabot Corporation: TS 622, TS 382, and TS 530
Colloidal silica—TG-C413 (HMDZ), and TG-C390 (OTES)
Mineral oil—Clairsol 370 (Petrochem Carless Ltd., Surrey England)

### NaCl

Cesium formate brine (SG 1.8/2.2) from Cabot Corporation
Nonionic surfactants: Synperonic A3 (Croda), C12E06 (Syngenta), and Span® 80 (Sigma Aldrich)
KemVert™ surfactant (Kemira)

### Bentone® 38 (Element's Specialites)

Cesium phosphate (SG 2.7) made from cesium hydroxide from Cabot Corporation (Tanco Mine, Canada) and reacted with phosphoric acid from Sigma Aldrich.

### Methods

### Preparation of Pickering Emulsion

Emulsions were prepared using the following general method. First the silica was dispersed in the oil and then sonicated for 30 seconds with the sonic probe at 50% power. CsFo brine or Cs₂HPO₄ brine was then added and the emulsion homogenised. “CsFo” is used as an abbreviation for “cesium formate.” The Cs₂HPO₄ brine is also referred to as cesium phosphate brine. Two methods of emulsification were used, the first was to use the sonic probe at 50% power for 30-60 seconds, and the second was to use the homogeniser at 18000 rpm for 2 minutes. For emulsions containing organoclay (Bentone®) and surfactant (KemVert™), the silica was dispersed in the oil after the addition of both of these components. Emulsions greater than 100 ml in volume were prepared using the following method. First the silica was dispersed in the oil by stirring/folding it in. Once in the oil, the dispersion was stirred magnetically for 5 minutes. After stirring, the dispersion was then sonicated using the S14 probe at 60% power for 2.5 minutes. CsFo brine or Cs₂HPO₄ brine was then added and the emulsion homogenised using the Ultra Turrax at 25000 rpm for 5 minutes.

### Preparation of “Standard” Surfactant-Based Emulsion (LSOBM)

The standard LSOBM was made using Silverson high shear mixer with square-hole high shear impeller screen. Base oil—Clairsol 370 was mixed with both KemVert™ 1899 and KemVert™ 1764 emulsifiers first for 5 minutes. After that, Bentone® 38, an organoclay, was added and mixed for 35 minutes. At the end, brine was added and whole system was mixed for another 20 minutes. Therefore, total mixing time was 60 minutes, and the Silverson mixer was set at 6000 rpm (+/−200 rpm). Table 1 shows a formulation of Standard LSOBM calculated for 1 lab bbl. Specific gravity (SG) as used here and throughout this application is unitless and the reference substance was water (25° C.) determined with SG at about 1 atm and 25° C.

TABLE 1

| | | SG (specific | | |
|---|---|---|---|---|
| Additives | TRADENAME | gravity) | grams | mL |
| Base Oil | Clairsol 370 | 0.80 | 135.0 | 168.7 |
| Primary | KemVert ™ 1899 | 0.95 | 5.0 | 5.3 |
| Emulsifier | | | | |
| Secondary | KemVert ™ 1764 | 1.00 | 3.9 | 3.9 |
| Emulsifier | | | | |
| Organoclay | Bentone ® 38 | 1.70 | 6.0 | 3.5 |
| Brine | Cesium Formate | 2.20 | 371.1 | 168.7 |
| | | | 520.9 | 350.00 |

### Preparation of Pickering Emulsion Containing Colloidal Silica (TG-C390) and Fumed Silica (TS622)

15 wt % TG-C390 in oil (500 ml) was dispersed using the sonic probe, cesium salt brine (500 ml) was then added and the sample homogenised using ultra turrax at 25000 rpm for 5 minutes. TS622 (2 wt % unless otherwise indicated) was then added with respect to TG-C390.

### Characterization of Emulsions

### Particle Size

The particle size of emulsions was measured using the Malvern Mastersizer 2000, optical microscopy and cryogenic SEM (cryo SEM).

Particle size measurements made on the Mastersizer 2000 were performed using the Hydro uP dispersion cell. The dispersion cell was filled with Clairsol 370 oil and left to allow thermal equilibrium to take place before checking the cleanliness of the system. Once clean, a background was determined, the laser aligned and a background measurement taken. Measurements conditions and settings included the following:

| | |
|---|---|
| Dispersion Cell | Hydro uP, |
| Dispersant | Clairsol 370, |
| Background Sweep | 20000 (20 seconds), |
| Measurement Time | 10000 (10 seconds), |
| Number of Measurements | 30, |
| Stirrer/Pump Speed | 2500 rpm. |

Optical microscope images were taken on an Olympus BX51 microscope. One drop of the emulsion sample was placed on a glass slide and images taken at the desired magnification. Cryo SEM was performed. Droplets of the sample were put onto rivets that were plunge frozen in liquid nitrogen slush. The frozen samples were the transferred to the PP2000 prep chamber where they were fractured. The samples were then sublimed at −95° C. for 4 minutes, followed by being platinum coated, before being transferred into the SEM. The samples were imaged at 3 kV at a working distance of 5 mm at varying magnifications. Sedimentation was observed visually as well as being measured on the Lumisizer.

### Emulsion Stability—Hot Rolling Test

Hot Rolling test was performed to determine the effect of thermal ageing on Pickering emulsion properties. The fluid (350 mL each time) was pressurized in Hot Roll Cell by nitrogen gas set to 13.8 bar (200 psi). Roller oven was heated up to 175° C. or 150° C. and the cells were rolled for 16 and 48 hours.

### Results—Cesium Formate Brine

### Example 1

### —Using Hydrophilic Silica

Emulsions with cesium formate brine were prepared using hydrophilic silica (250 nm) using Span® 80 to aid the dispersability of the silica in the oil phase. It was found that at low v/v % (10%) of the dispersed phase (water), a w/o emulsion was prepared. Upon analysing a microscope image, the emulsion droplets were about 40 microns in diameter.

### —Using Hydrophobic Silica

Six types of silica were tested to assess their suitability in stabilizing w/o emulsion, where the continuous phase is Clairsol 370 mineral oil and the dispersed phase is cesium formate brine. The six silicas tested were the following:

Aerosil® R974—Fumed silica modified with dimethyldichlorosilane
TS 622—Cabot fumed silica modified with dimethyldichlorosilane
TS 530—Cabot fumed silica modified with trimethylsilane.
TS 382—Cabot fumed silica modified with octylsilane.
Cab-o-sil® TG-C390—Colloidal silica modified with trimethoxyoctylsilane
Cab-o-sil® TG-C413—Colloidal silica modified with hexamethyldisalizane.

It was established that all of the above silica (except TS 530 and TS 382) stabilized a w/o emulsion where the dispersed phase is cesium formate at 50 v/v %.

A microscope image of a w/o emulsion made using Aerosil® R974 along with a particle size measurement made using a Malvern Mastersizer 2000 was taken and this showed that emulsion droplets were from about 15 to 80 μm in diameter. Microscope images of w/o emulsion stabilized by TS622 and TG-C390 and TG-C413 with cesium formate brine as the dispersed phase were obtained and these showed that the emulsion droplets were about the same size. The emulsion stabilized with TG-C413 had a slightly smaller emulsion droplet size of from about 20-40 μm in diameter. The fumed silica emulsion particle size was about 30 μm, and the colloidal silica emulsion particle size was about 10 μm.

To assess the stability of the emulsions toward coalescence, a study was conducted on emulsions stabilized by TG-C413 silica at different concentrations. Two emulsions were made, using TG-C413 at 1 wt % and 5 wt %. Both were prepared using the Ultra Turrax, and kept constantly rotating on a carousel and the height/volume of water was measured over time. The results for the two tests are shown in Tables 2-3 below.

TABLE 2
Coalescence data for TG-C413 at 5 wt %

| | | | % of Total Volume of |
|---|---|---|---|
| Time (mins) | Water Height (mm) | Volume (ml) | Water Added |
| 0 | 0 | 0 | 0 |
| 30 | 0 | 0 | 0 |
| 60 | 0 | 0 | 0 |
| 180 | 5 | 14.2 | 14.2 |
| 1380 | 22 | 8.14 | 62.6 |
| 1440 | 22 | 8.14 | 62.6 |

TABLE 3
Coalescence data for TG-C413 at 1 wt %

| | | | % of Total Volume of |
|---|---|---|---|
| Time (mins) | Water Height (mm) | Volume (ml) | Water Added |
| 0 | 0 | 0 | 0 |
| 30 | 4 | 1.48 | 11.4 |
| 60 | 10 | 3.7 | 28.5 |
| 1140 | 30 | 11.1 | 85.4 |
| 1440 | 30 | 11.1 | 85.4 |

FIG. 7 shows a graph which shows coalescence data for emulsions stabilized by 1 and 5 wt % TG-C413.

It can be seen from the above data that as the wt % of silica increases, the stability towards coalescence increases. Stability against coalescence improved with increasing colloidal silica content. It was found that at 15 wt % of the colloidal silica, emulsions stable to coalescence could be produced.

### Surfactant Effect on Particle Size

Two surfactants, labelled as primary emulsifier KemVert™ 1899 and KemVert™ 1764, were added to the oil phase to assess their effect on the droplet size of the emulsion.

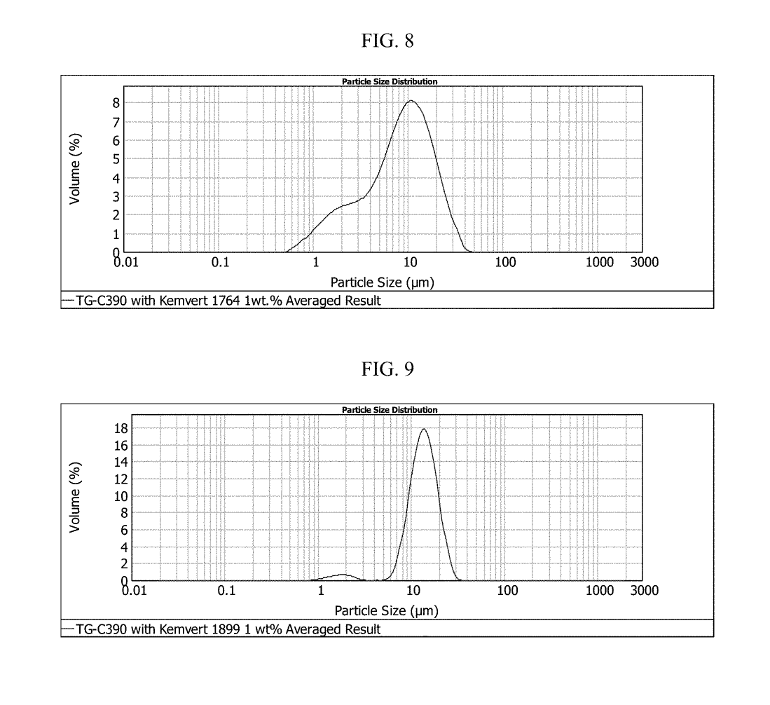

Particle size analysis was performed on the emulsions and the results are shown in FIGS. 8 and 9. The two graphs show the results. The graph in FIG. 8 shows particle size data for TG-C390 with 1 wt % KemVert™ 1764, confirming that the size of the emulsion droplets were about 0.5-4 μm. The graph in FIG. 9 shows particle size data for TG-C390 with 1 wt % KemVert™ 1899, confirming an emulsion droplet size of from about 5-30 μm.

One of the indicated colloidal silica systems, TG-C390 was used in further studies which are described in the following additional examples.

### Stability Testing Using TG-C390 (Colloidal Silica)

Stability against sedimentation was examined in emulsions prepared with the indicated colloidal silica (TG-C390) with use of Bentone® 38 and fumed silica, which are described in the following Examples 2 and 3.

### Example 2

### TG-C390—Stability Tests for Emulsions Using Bentone® 38

In this preparation, Bentone® 38 is dispersed into mineral oil using Kemvert™ 1899 together with colloidal silica. The brine phase is then added and emulsified. More specifically, the process for emulsification with Bentone® 38 was to first add the KemVert™ 1899 to the oil. The Bentone® 38 was then added, and then the TG-C390 silica added with sonication to aid dispersability. 50 v/v % cesium formate brine was then added as the dispersed phase and the emulsion has homogenized using ultra turrax. Table 4 shows the amount of Bentone® 38 and KemVert™ 1899 present in the different emulsions.

TABLE 4

| Sample | wt % Bentone ® 38 | wt % KemVert ™ 1899 | |
|---|---|---|---|
| AL 193 | 0 | 3 | (0.5) |
| AL 192 | 4.1 | 3 | (0.5) |
| AL 194 | 5 | 3 | (0.5) |
| AL 195 | 10 | 3 | (0.5) |
| AL 203 | 5 | 6.66 | (1) |
| AL 204 | 10 | 6.66 | (1) |
| AL 196 | 5 | 10 | (1.5) |
| AL 197 | 10 | 10 | (1.5) |

From images taken of the emulsions, it can be seen that at concentrations of 10 wt % Bentone® 38 and 1/1.5 wt % KemVert™ 1899 that the emulsions are relatively stable against sedimentation. Six emulsions were prepared with 15 wt % TG-C390 and with 1.5 wt % KemVert™ 1899 but with concentrations of Bentone® 38 ranging from 5-10 wt % in 1% increments. All of the emulsions are relatively stable against sedimentation. It was found that stability against sedimentation improved with addition of clay, with Kemvert™ 1899 as a wetting agent to disperse the clay (Bentone® 38).

### Example 3

### TG-C390—Stability Tests for Emulsions Using Fumed Silica

The stability of emulsions that contained fumed silica in addition to the colloidal silica was studied. The process for emulsification of the silica system of this example is to first disperse the TG-C390 silica in oil, add cesium formate brine (50 v/v %), and then emulsify. Once the sample has been homogenized, such as using ultra turrax, the TS622 fumed silica is mixed into the sample. No Kemvert1899™ surfactant is used prior to forming the Pickering emulsion. It was found that stability against sedimentation was improved by addition of TS622 fumed silica. Advantageously, this does not require addition of Kemvert™ 1899 surfactant prior to forming the Pickering emulsion. Coalescence stability was equivalent to invert emulsion without TS622.

### Example 4

### Cryogenic SEM Results

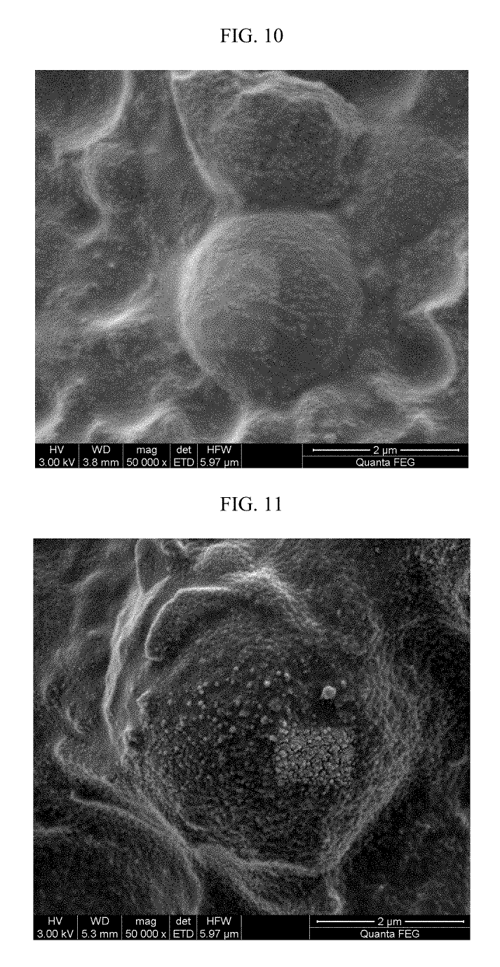

Cryogenic SEM imaging was performed on two different emulsion systems using cesium formate which did not include clay or fumed silica. Both were stabilized by TG-C390 silica at 15 wt % but one also contained KemVert™ 1899 at 1 wt %. FIG. 10 shows an image of the emulsion droplets stabilized by both TG-C390 (15 wt %) and KemVert™ 1899 (1 wt %).

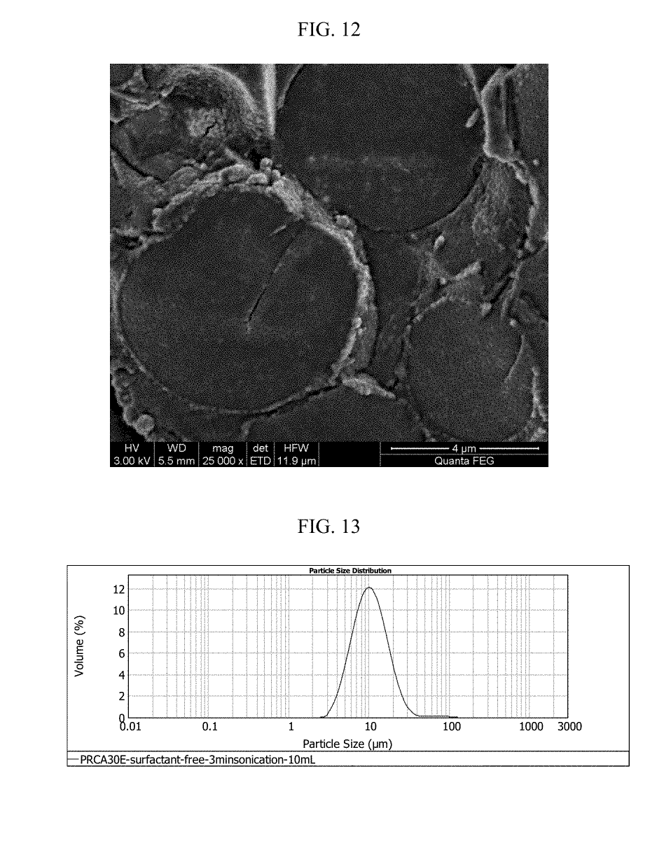

It can be seen from the image in FIG. 10 that there are silica particles at the interface, indicating that a Pickering emulsion has been produced. FIG. 11 (50,000×) and FIG. 12 (25,000×) show cryogenic SEM images at different magnifications of the emulsion stabilized by 15 wt % TG-C390. It can be seen from the images in FIGS. 11 and 12 that the silica coverage on the brine droplets is denser in the surfactant free system. As indicated in Examples 2 and 3, stability against sedimentation of these emulsion systems can be further improved with addition of clay (albeit together with the surfactant), or with addition of fumed silica.

Results—Cesium Phosphate (Cs₂HPO₄) Brine

### Example 5

Emulsions were also prepared using Cs₂HPO₄ as the dispersed phase. FIG. 13 shows the results of a particle size analysis (measured on the Malvern mastersizer) of the Cs₂HPO₄ emulsion stabilised by 15 wt % TG-C390 silica with Cs₂HPO₄ as the dispersed phase.

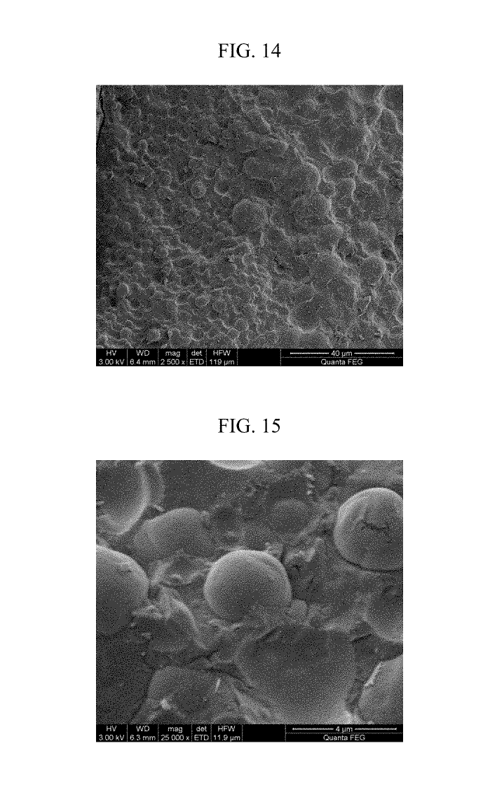

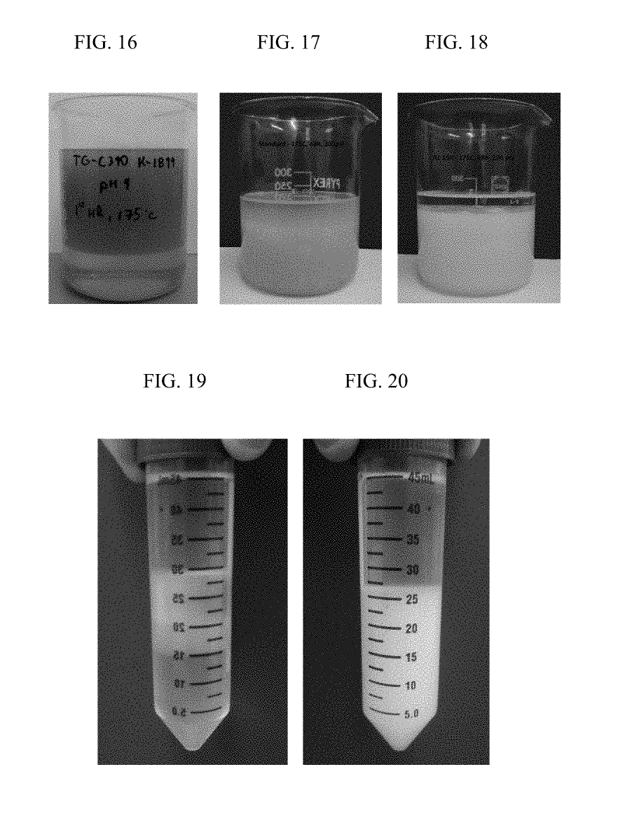

FIG. 14 (2500×) and FIG. 15 (25000×) show cryogenic SEM images of a Cs₂HPO₄ emulsion at different magnifications that are stabilized with 15 wt % TG-C390. The emulsion drops are clearly discernible and have a texture presumably due to colloidal silica at the interface.

### Hot Rolling Stability Tests

### Example 6

Comparison of Stability for Pickering Type Low Solids Oil Based Completion Fluid (LSOBCF) Against Regular Surfactant Based LSOBCF, Both with Cesium Formate Internal Phase

Three emulsion samples prepared with cesium formate brine as the dispersed phase were tested for thermal stability using a hot rolling stability test: 1) sample AL214_3 (15 wt % TG-C390 and 1 wt % KemVert™ 1899, 4 wt % Bentone® 38), 2) AL190 (15 wt % TG-C390), and 3) Standard LSOBM. The standard LSOBM was prepared as indicated above. The AL190 sample was emulsified using a homogenizer at 25000 rpm for 5 minutes. The hot rolling test is described above. A Hot Rolling Test that was carried out at 175° C. for 48 hours indicated that samples AL190 and Standard LSOBM were stable. Sample AL214_3 was hot rolled at 175° C. for only 16 hours. Photographic images of the samples after the Hot Rolling Test are shown in FIG. 27 (AL214_3), FIG. 17 (Standard LSOBM), and FIG. 18 (AL190). For samples AL190 and Standard LSOBM, there were no signs of destabilization such as a separate layer of the internal phase. The separation of base oil was observed in both samples (the top layer), but the process was seen in other oil-based muds including used field muds and seems to be accepted as a common phenomenon, presumably due to gravitational settling of the heavy emulsion droplets. For the Sample AL214_3 that was hot rolled at 175° C. for only 16 hours, internal phase separation from the whole system indicated instability of the sample and longer tests were not carried out for this sample.

To identify which of the two samples AL190 or Standard LSOBM was more stable, both the samples were centrifuged for 60 minutes at 4000 rpm at 175° C. for 48 hours, with results that further indicated that samples AL190 and Standard LSOBM were stable with AL190 being more stable than LSOBM. Photographic images of the samples after this centrifugation test are shown in FIG. 19 (Standard LSOBM) and FIG. 20 (AL190). These test results showed unambiguously that Pickering emulsion AL190 is more stable than Standard LSOBM, as there was no evidence of internal phase separation. There were no signs of destabilization such as separate layer of the internal phase.

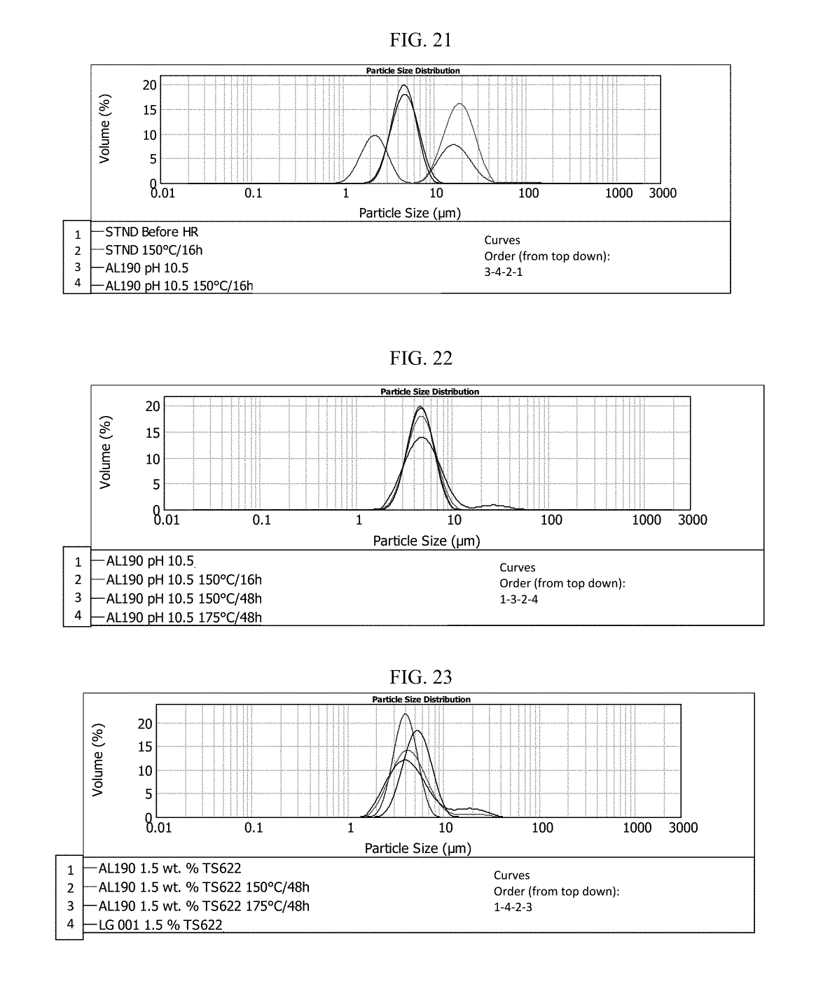

Particle size distributions, as determined with a Malvern Masterizer, also were determined before and after hot rolling tests performed at 150° C. for 16 hours for samples of LSOBM (“STND”) and AL190, with the results shown in FIG. 21 and in Table 5. These results show the stability of the AL190 Pickering emulsion over the standard surfactant based LSOBM. In the Malvern particle size distribution determinations, the volume median diameter d(0.5) is the diameter where 50% of the distribution is above and 50% is below, d(0.9) is the diameter where 90% of the volume distribution is below this value, and d(0.1) is the diameter where 10% of the volume distribution is below this value.

TABLE 5

| Sample | d(0.1) μm | d(0.5) μm | d(0.9) μm |
|---|---|---|---|
| STND before HR | 1.67 | 3.89 | 22.99 |
| STND 150° C./16 h | 11.63 | 18.77 | 29.66 |
| AL190 pH 10.5 | 3.17 | 4.66 | 6.79 |
| AL190 pH 10.5 150° C./16 h | 3.12 | 4.77 | 7.24 |

A comparison of particle size distributions before and after hot rolling tests was performed at various temperatures and durations on samples of AL190, with the results shown in FIG. 22 and in Table 6. These results show the thermal stability of AL190 sample.

TABLE 6

| Sample | d(0.1) μm | d(0.5) μm | d(0.9) μm |
|---|---|---|---|
| AL190 pH 10.5 | 3.17 | 4.66 | 6.79 |
| AL190 pH 10.5 150° C./16 h | 3.12 | 4.77 | 7.24 |
| AL190 pH 10.5 150° C./48 h | 3.19 | 4.72 | 6.93 |
| AL190 pH 10.5 175° C./48 h | 2.93 | 4.98 | 9.15 |

### Example 7

Emulsion samples for cesium formate brines were prepared with the AL190 of the previous example supplemented with fumed silica (TS622). In this example, AL190_6 contained 15 wt % TG-C390 and 1.5 wt % TS622. These samples were tested for thermal stability using a hot rolling stability test at various temperatures and durations, and the samples also were tested for particle size distribution (Malvern mastersizer). From visual examination, the sample AL190_6 was stable after the hot rolling test carried out at 150° C. for 48 hours and at 175° C. for 48 hours. A comparison of particle size distributions before and after hot rolling tests was performed at various temperatures and durations on samples of AL190_6, with the results shown in FIG. 23 and in Table 7. These results show the thermal stability of the AL190_6 sample.

TABLE 7

| Sample | d(0.1) μm | d(0.5) μm | d(0.9) μm |
|---|---|---|---|
| AL190 1.5 wt. % TS622 | 2.81 | 3.99 | 5.63 |
| AL190 1.5 wt. % TS622 | 2.59 | 4.36 | 7.89 |
| 150° C./48 h | | | |
| AL190 1.5 wt. % TS622 | 2.43 | 4.35 | 12.20 |
| 175° C./48 h | | | |
| LG 001 1.5% TS622 | 3.50 | 5.31 | 7.97 |

### Example 8

Thermal Stability of Pickering Emulsion with Cesium Phosphate as Internal Phase

Cesium phosphate was used as an internal phase to formulate Pickering emulsions stabilized by silica. Sample AL 218 was made using 15 wt. % C390 in Clarisol oil and cesium phosphate as the dispersed phase. The sample contained no other additives. Sample AL238 was made using 15 wt % colloidal silica (TG-C390) in oil (500 ml), cesium phosphate (500 ml), and 2 wt % fumed silica (TS622) with respect to oil phase and 1 wt % Kemvert™ with respect to the colloidal silica (TG-C390). Sample AL239 was formulated using 15 wt % TG-C390 in oil (500 ml), cesium phosphate (500 ml), and 2 wt % TS622 with respect to oil phase, but no surfactant was used. Stability was tested using a hot rolling test for the emulsions at 175° C./48 hrs, at 150° C./48 hrs, and at 150° C./16 hrs.

All three Pickering emulsions AL218, AL238, and AL239 with cesium phosphate as an internal phase indicated a lower stability when compared to Pickering emulsions with cesium formate brine as an internal phase (AL190). Samples AL218 and AL239 were more stable after the hot rolling test was carried out at 150° C., for 16 hours. Similar Pickering emulsions with cesium formate brine were very stable, and could survive 175° C. for 48 hours.

The present invention includes the following aspects/embodiments/features in any order and/or in any combination:

1. A well fluid comprising a particle stabilized emulsion, wherein the emulsion comprises a first phase comprising hydrocarbon fluid, a second phase comprising an aqueous brine, and solid particles, wherein at least a portion of the solid particles are arranged at an interface between the first phase and the second phase.
2. The well fluid of any preceding or following embodiment/feature/aspect, wherein the solid particles are silica.
3. The well fluid of any preceding or following embodiment/feature/aspect, wherein the solid particles are colloidal silica, fumed silica, or a combination thereof.
4. The well fluid of any preceding or following embodiment/feature/aspect, wherein said brine has a density of at least 1.5 g/cm³.
5. The well fluid of any proceeding or following embodiment/feature/aspect, wherein the solid particles are hydrophobic fumed silica.
6. The well fluid of any preceding or following embodiment/feature/aspect, wherein the solid particles are hydrophobic colloidal silica.
7. The well fluid of any preceding or following embodiment/feature/aspect, wherein the emulsion is stable up to at least 100° C.
8. The well fluid of any preceding or following embodiment/feature/aspect, wherein the emulsion is stable up to at least 180° C. for 48 hours.
9. The well fluid of any preceding or following embodiment/feature/aspect, wherein particle stabilized emulsion is a particle stabilized water-in-oil invert emulsion, wherein the first phase of the emulsion is an external phase comprising the hydrocarbon fluid and the second phase is an internal phase comprising aqueous brine droplets dispersed in the hydrocarbon fluid, wherein at least a portion of the solid particles are arranged at an interface between the aqueous brine droplets and the hydrocarbon fluid.
10. The well fluid of any preceding or following embodiment/feature/aspect, wherein the aqueous brine comprises a cesium salt.
11. The well fluid of any preceding or following embodiment/feature/aspect, wherein the aqueous brine comprises cesium formate, cesium acetate, cesium phosphate, cesium tungstate, or any combination thereof.
12. The well fluid of any preceding or following embodiment/feature/aspect, wherein the aqueous brine comprises cesium phosphate or cesium formate or both.
13. The well fluid of any preceding or following embodiment/feature/aspect, further comprising organophilic clay, bentonite, or other clay particles and/or other viscosifiers (e.g., a polymer based viscosifier).
14. The well fluid of any preceding or following embodiment/feature/aspect, wherein the hydrocarbon fluid is diesel oil, mineral oil, synthetic oil, or any combinations thereof.
15. The well fluid of any preceding or following embodiment/feature/aspect, wherein said internal phase further comprises water in an amount of at least about 1% by weight based on weight of said internal phase.
16. The well fluid of any preceding or following embodiment/feature/aspect, wherein the aqueous brine comprise from about 1% to about 80% by weight based weight of said internal phase.
17. The well fluid of any preceding or following embodiment/feature/aspect, wherein said internal phase comprises aqueous brine containing a cesium salt having a density of from about 1.5 g/cm³ to about 2.75 g/cm³.
18. The well fluid of any preceding or following embodiment/feature/aspect, wherein said well fluid is a drilling fluid, completion fluid, workover fluid, fracturing fluid, well suspension, gravel pack fluid, or packer fluid.
19. The well fluid of any preceding or following embodiment/feature/aspect in the absence of any surfactant.
20. The well fluid of any preceding or following embodiment/feature/aspect in the absence of any stabilizing component other than said solid particles.
21. The well fluid of any preceding or following embodiment/feature/aspect, wherein the solid particles (e.g., silica particles) have a contact angle at the interface of less than 90°, as measured with respect to the second phase.
22. The well fluid of any preceding or following embodiment/feature/aspect, wherein the solid particles (e.g., silica particles) have a contact angle at the interface of greater than 90°, as measured with respect to the second phase.
23. The present invention relates to a well fluid comprising a particle stabilized emulsion, wherein the emulsion comprises a first phase comprising hydrocarbon fluid, a second phase comprising an aqueous alkali metal brine, and solid silica particles, wherein at least a portion of the solid silica particles are arranged at an interface between the first phase and the second phase.
24. The present invention relates to a method for producing a particle stabilized emulsion for well fluids, comprising:

dispersing solid particles, such as solid silica particles, in a hydrocarbon fluid to form a dispersion;

adding aqueous brine (such as an alkali metal brine) to the dispersion to form a mixture;

emulsifying the mixture to form an emulsion comprising a first phase comprising hydrocarbon fluid, a second phase comprising an aqueous brine, wherein at least a portion of the solid particles are arranged at an interface between the first phase and the second phase.

25. The method of any preceding or following embodiment/feature/aspect, wherein the first phase of the emulsion is an external phase comprising the hydrocarbon fluid and the second phase is an internal phase comprising aqueous brine dispersed in the hydrocarbon fluid.
26. The method of any preceding or following embodiment/feature/aspect with no addition of surfactant occurring before the forming of the emulsion.
27. The method of any preceding or following embodiment/feature/aspect, wherein the emulsifying comprises mechanical mixing with sonic vibration (e.g., ultrasonication), a high shear mixer (e.g., rotor/stator mixer), homogenization, or microfluidization.
28. A method to drill a well comprising drilling said well in the presence of the well fluid of any preceding or following embodiment/feature/aspect.
29. The well fluid of any preceding or following embodiment/feature/aspect, further comprising at least one surfactant present in an amount to reduce the viscosity of said oil fluid.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A well fluid comprising a particle stabilized emulsion, wherein the emulsion comprises a first phase comprising hydrocarbon fluid, a second phase comprising an aqueous brine, and solid particles, wherein at least a portion of the solid particles are arranged at an interface between the first phase and the second phase.

2. The well fluid of claim 1, wherein the solid particles are colloidal silica, fumed silica, or a combination thereof.

3. The well fluid of claim 1, wherein said brine has a density of at least 1.5 g/cm³.

4. The well fluid of claim 1, wherein the solid particles are hydrophobic fumed silica.

5. The well fluid of claim 1, wherein the solid particles are hydrophobic colloidal silica.

6. The well fluid of claim 1, wherein the emulsion is stable up to at least 100° C.

7. The well fluid of claim 1, wherein the emulsion is stable up to at least 180° C. for 48 hours.

8. The well fluid of claim 1, wherein particle stabilized emulsion is a particle stabilized water-in-oil invert emulsion, wherein the first phase of the emulsion is an external phase comprising the hydrocarbon fluid and the second phase is an internal phase comprising aqueous brine droplets dispersed in the hydrocarbon fluid, wherein at least a portion of the solid particles are arranged at an interface between the aqueous brine droplets and the hydrocarbon fluid.

9. The well fluid of claim 1, wherein the aqueous brine comprises a cesium salt or a cesium salt blended with at least one potassium salt.

10. The well fluid of claim 1, wherein the aqueous brine comprises cesium formate, cesium acetate, cesium phosphate, cesium tungstate, or any combination thereof.

11. The well fluid of claim 1, wherein the aqueous brine comprises cesium phosphate.

12. The well fluid of claim 1, further comprising organophilic clay, bentonite, or other clay particles.

13. The well fluid of claim 1, wherein the hydrocarbon fluid is diesel oil, mineral oil, synthetic oil, or any combinations thereof.

14. The well fluid of claim 1, wherein said internal phase further comprises water in an amount of at least about 1% by weight based on weight of said internal phase.

15. The well fluid of claim 1, wherein the aqueous brine comprise from about 1% to about 80% by weight based weight of said internal phase.

16. The well fluid of claim 1, wherein said internal phase comprises aqueous brine containing a cesium salt having a density of from about 1.5 g/cm³ to about 2.75 g/cm³.

17. The well fluid of claim 1, wherein said well fluid is a drilling fluid, completion fluid, workover fluid, fracturing fluid, well suspension, gravel pack fluid, or packer fluid.

18. The well fluid of claim 1, wherein the well fluid is in the absence of any surfactant.

19. The well fluid of claim 1, wherein the well fluid is in the absence of any stabilizing component other than said solid particles.

20. The well fluid of claim 1, wherein the solid particles have a contact angle at the interface of less than 90°, as measured with respect to the second phase.

21. The well fluid of claim 1, wherein the solid particles have a contact angle at the interface of greater than 90°, as measured with respect to the second phase.

22. A well fluid comprising a particle stabilized emulsion, wherein the emulsion comprises a first phase comprising hydrocarbon fluid, a second phase comprising an aqueous alkali metal brine, and solid particles, wherein at least a portion of the solid particles are arranged at an interface between the first phase and the second phase.

23. A method for producing a particle stabilized emulsion for well fluids, comprising:
dispersing solid particles in a hydrocarbon fluid to form a dispersion;
adding aqueous brine to the dispersion to form a mixture;
emulsifying the mixture to form an emulsion comprising a first phase comprising hydrocarbon fluid, a second phase comprising an aqueous brine, wherein at least a portion of the solid particles are arranged at an interface between the first phase and the second phase.

24. The method of claim 23, wherein the first phase of the emulsion is an external phase comprising the hydrocarbon fluid and the second phase is an internal phase comprising aqueous brine dispersed in the hydrocarbon fluid.

25. The method of claim 23 with no addition of surfactant occurring before the forming of the emulsion.

26. The method of claim 23, wherein the emulsifying comprises mechanical mixing with sonic vibration, a high shear mixer, homogenization, or microfluidization.

27. A method to drill a well comprising drilling said well in the presence of the well fluid of claim 1.

28. A method to drill a well comprising drilling said well in the presence of the well fluid of claim 8.

29. The well fluid of claim 1, further comprising at least one surfactant present in an amount to reduce the viscosity of said oil fluid.
